(19) United States
(12) Patent Application Publication
(10) Pub. No.: US 2015/0355752 A1
(43) Pub. Date: Dec. 10, 2015

(54) SENSOR-EQUIPPED DISPLAY DEVICE

(71) Applicant: Japan Display Inc., Tokyo (JP)

(72) Inventors: Hayato KURASAWA, Tokyo (JP); Koji ISHIZAKI, Tokyo (JP)

(21) Appl. No.: 14/735,305

(22) Filed: Jun. 10, 2015

(30) Foreign Application Priority Data
Jun. 10, 2014 (JP) 2014-119630

(51) Int. Cl. G06F 3/044

(52) U.S. Cl. CPC G06F 3/044; G06F 2203/04108

(57) ABSTRACT

A sensor-equipped display device is provided and includes a display panel and a detection electrode. The display panel includes a display area in which a plurality of pixels are arranged. The detection electrode includes an electrode pattern having conductive line fragments arranged on a detection surface which is parallel to the display area, wherein the electrode pattern includes a connection point at which ends of three line fragments are connected together.

### CROSS REFERENCES TO RELATED APPLICATIONS

The present application claims priority to Japanese Priority Patent Application JP 2014-119630 filed in the Japan Patent Office on Jun. 10, 2014, the entire content of which is hereby incorporated by reference.

### FIELD

Embodiments described herein relate generally to a sensor-equipped display device.

### BACKGROUND

Display devices including sensors which detect a contact or approach of an object are used commercially (they are often referred to as touchpanels). As an example of such sensors, there is a capacitive sensor which detects a contact or the like of an object based on a change in the capacitance between a detection electrode and a driving electrode facing each other with a dielectric interposed therebetween.

The detection electrodes and the driving electrodes are disposed to overlap with a display area to detect a contact or the like of an object therein. However, the detection electrodes and the driving electrodes disposed in such a manner and the pixels contained in the display area may generate interference which will generate a moiré.

Sensor-equipped display devices which can prevent or reduce a moiré are required.

### SUMMARY

This application relates generally to a display device including a sensor-equipped display device.

In an embodiment, a sensor-equipped display device is provided. The sensor-equipped display device includes a display panel including a display area in which a plurality of pixels are arranged; and a detection electrode including an electrode pattern having conductive line fragments arranged on a detection surface which is parallel to the display area, the detection electrodes configured to detect a contact or approach of an object to the detection surface, wherein the electrode pattern includes a connection point at which ends of three line fragments are connected together.

Additional features and advantages are described herein, and will be apparent from the following Detailed Description and the figures.

### BRIEF DESCRIPTION OF THE FIGURES

FIG. 1 is a perspective view which schematically shows the structure of a sensor-equipped display device of a first embodiment.

FIG. 2 is a view which schematically shows the basic structure and equivalent circuit of the display device.

FIG. 3 is a view which schematically shows an equivalent circuit of a subpixel of the display device.

FIG. 4 is a cross-sectional view which schematically shows the structure of the display device in part.

FIG. 5 is a plan view which schematically shows the structure of a sensor of the display device.

FIG. 6 is a view which illustrates a principle of sensing (mutual-capacitive sensing method) performed by the sensor of the display device.

FIG. 7 is a view which illustrates another principle of sensing (self-capacitive sensing method) performed by the sensor of the display device.

FIG. 8 is a view which illustrates said another principle of sensing (self-capacitive sensing method) performed by the sensor of the display device.

FIG. 9 is a view which illustrates a specific example of how to drive the sensor in the self-capacitive sensing method.

FIG. 10 is a view which schematically shows detection electrodes of the sensor of the display device, which are arranged in a matrix.

FIG. 11 is a view which schematically shows an arrangement example of unit pixels and electrode patterns in a display area.

FIG. 12 is a view which schematically shows another arrangement example of unit pixels and electrode patterns in a display area.

FIG. 13 is a view which schematically shows a unit pattern of the electrode pattern of the first embodiment.

FIG. 14 is a view which schematically shows a part of an electrode pattern of a second embodiment.

FIG. 15 is a view which schematically shows a part of an electrode pattern of a third embodiment.

FIG. 16 is a view which schematically shows a part of an electrode pattern of a fourth embodiment.

FIG. 17 is a view which schematically shows a part of an electrode pattern of a fifth embodiment.

FIG. 18 is a view which schematically shows a part of an electrode pattern of a sixth embodiment.

FIG. 19 is a view which schematically shows a part of an electrode pattern of a seventh embodiment.

FIG. 20 is a view which schematically shows a part of an electrode pattern of an eighth embodiment.

FIG. 21 is a view which schematically shows a part of an electrode pattern of a ninth embodiment.

FIG. 22 is a view which schematically shows a part of an electrode pattern of a tenth embodiment.

FIG. 23 is a view which schematically shows part of a display area of a variation 1.

FIG. 24 is a view which schematically shows part of a display area of a variation 2.

### DETAILED DESCRIPTION

In general, according to one embodiment, a sensor-equipped display device comprises a display panel and a detection electrode. The display panel includes a display area in which a plurality of pixels are arranged. The detection electrode includes an electrode pattern having conductive line fragments arranged on a detection surface which is parallel to the display area. And the electrode pattern includes a connection point at which ends of three line fragments are connected together.

Hereinafter, embodiments of the present application will be explained with reference to accompanying drawings.

Note that the disclosure is presented for the sake of exemplification, and any modification and variation conceived within the scope and spirit of the invention by a person having ordinary skill in the art are naturally encompassed in the scope of invention of the present application. Furthermore, a width, thickness, shape, and the like of each element are depicted schematically in the Figures as compared to actual embodiments for the sake of simpler explanation, and they are not to limit the interpretation of the invention of the present application. Furthermore, in the description and Figures of the present application, structural elements having the same or similar functions will be referred to by the same reference numbers and detailed explanations of them that are considered redundant may be omitted.

### First Embodiment

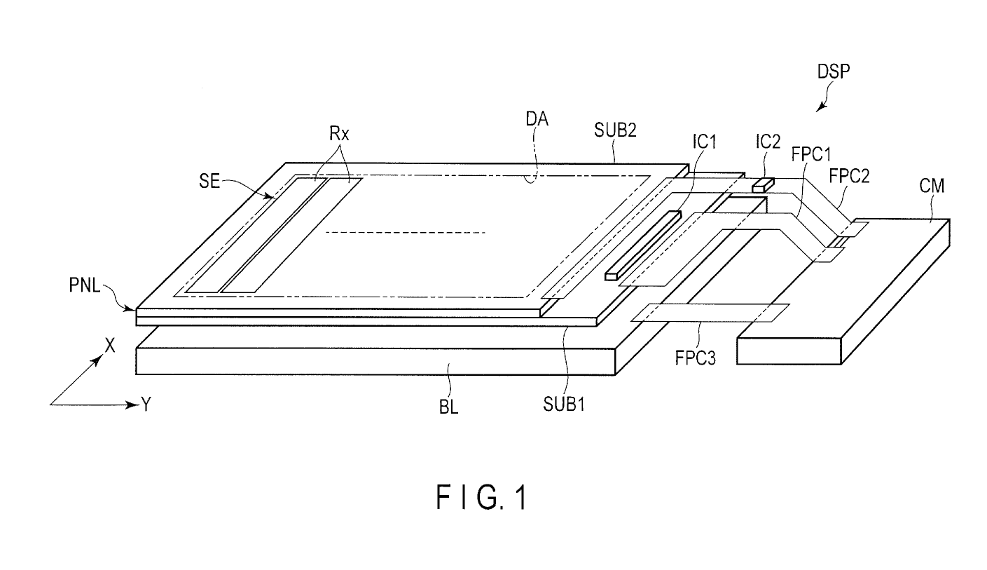

FIG. 1 is a perspective view which schematically shows the structure of a sensor-equipped display device of a first embodiment. In this embodiment, a sensor-equipped display device is a liquid crystal display device. However, no limitation is intended thereby, and the display device may be self-luminous display devices such as an organic electroluminescent display device and the like, electronic paper display devices including electrophoresis elements and the like, and other flatpanel display devices. Furthermore, the sensor-equipped display device of the present embodiment may be adopted in various devices such as smartphones, tablet terminals, mobilephones, notebook computers, and gaming devices.

The liquid crystal display device DSP includes an active matrix type liquid crystal display panel PNL, driving IC chip IC1 which drives the liquid crystal display panel PNL, capacitive sensor SE, driving IC chip IC2 which drives the sensor SE, backlight unit BL which illuminates the liquid crystal panel PNL, control module CM, and flexible printed circuits FPC1, FPC2, and FPC3.

The liquid crystal display panel PNL includes a first substrate SUB1, second substrate SUB2 opposed to the first substrate SUB1, and liquid crystal layer (liquid crystal layer LQ which is described later) held between the first substrate SUB1 and the second substrate SUB2. In the present embodiment, the first substrate SUB1 may be reworded into an array substrate and the second substrate SUB2 may be reworded into a countersubstrate. The liquid crystal display panel PNL includes a display area (active area) DA which displays images. The liquid crystal display panel PNL is a transmissive type display panel having a transmissive display function which displays images by selectively transmitting the light from the backlight unit BL. The liquid crystal display panel PNL may be a transflective type display panel having a reflective display function which displays images by selectively reflecting external light in addition to the transmissive display function.

The backlight unit BL is disposed at the rear surface side of the first substrate SUB1. As a light source of the backlight unit BL, various models can be used including luminescent diode (light emitting diode, LED) and the like. If the liquid crystal display panel PNL is of reflective type having the reflective display function alone, the liquid crystal display device DSP does not necessarily include the backlight unit BL.

The sensor SE includes a plurality of detection electrodes Rx. The detection electrodes Rx are provided with a detection surface (X-Y flat surface) which is, for example, above and parallel to the display surface of the liquid crystal display panel PNL. In the example depicted, the detection electrodes Rx are extended substantially in direction X and are arranged side-by-side in direction Y. Otherwise, the detection electrodes Rx may be extended in direction Y and arranged side-by-side in direction X, or the detection electrodes Rx may be formed in an island shape and be arranged in a matrix in directions X and Y. In this embodiment, directions X and Y are orthogonal to each other.

The driving IC chip IC1 is mounted on the first substrate SUB1 of the liquid crystal display panel PNL. The flexible printed circuit FPC1 connects the liquid crystal display panel PNL with the control module CM. The flexible printed circuit FPC2 connects the detection electrodes Rx of the sensor SE with the control module CM. The driving IC chip IC2 is mounted on the flexible printed circuit FPC2. The flexible printed circuit FPC3 connects the backlight unit BL with the control module CM.

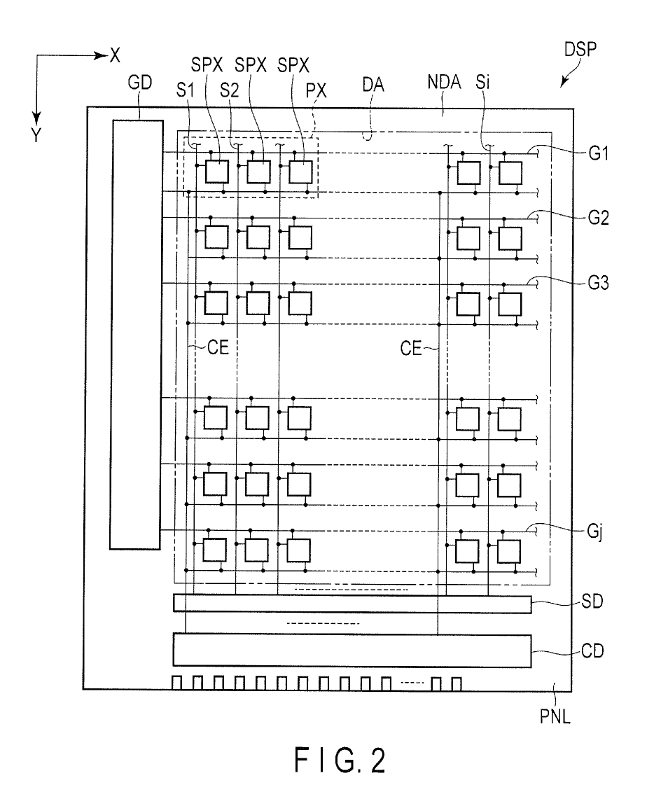

FIG. 2 is a view which schematically shows the basic structure and equivalent circuit of the liquid crystal display device DSP shown in FIG. 1. In addition to the liquid crystal display panel PNL, the liquid crystal display device DSP includes a source line driving circuit SD, gate line driving circuit GD, common electrode driving circuit CD within a non-display area NDA which is outside the display area DA.

The liquid crystal display panel PNL includes a plurality of subpixels SPX within the display area DA. The subpixels SPX are arranged in a matrix of i×j (i and j are positive integers) in directions X and Y. Subpixels SPX are provided to correspond to colors such as red, green, blue, and white. A unit pixel PX is composed of subpixels SPX those correspond to different colors, and is a minimum unit which constitutes a displayed color image. Furthermore, the liquid crystal display panel PNL includes j gate lines G (G1 to Gj), i source lines S (S1 to Si), and common electrode CE within the display area DA.

The gate lines G are extended substantially linearly in direction X to be drawn outside the display area DA and connected to the gate line driving circuit GD. Furthermore, the gate lines G are arranged in direction Y at intervals. The source lines S are extended substantially linearly in direction Y to be drawn outside the display area DA to cross the gate lines G. Furthermore, the source lines S are arranged in direction X at intervals. The gate lines G and the source lines S are not necessarily extended linearly and may be extended partly being bent. The common electrode CE is drawn outside the display area DA to be connected with the common electrode driving circuit CD. The common electrode CE is shared with a plurality of subpixels SPX. The common electrode CE is described later in detail.

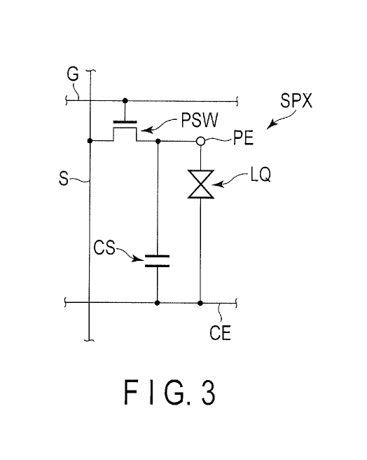

FIG. 3 is a view which shows an equivalent circuit of the subpixel SPX shown in FIG. 2. Each subpixel SPX includes a switching element PSW, pixel electrode PE, common electrode CE, and liquid crystal layer LQ. The switching element PSW is formed of, for example, a thin film transistor. The switching element PSW is electrically connected to the gate line G and the source line S. The switching element PSW is of either top gate type or bottom gate type. The semiconductor layer of the switching element PSW is formed of, for example, polysilicon; however, it may be formed of amorphous silicon, oxide semiconductor, or the like. The pixel electrode PE is electrically connected with the switching element PSW. The pixel electrode PE is opposed to the common electrode CE. The common electrode CE and the pixel electrode PE form a retaining capacitance CS.

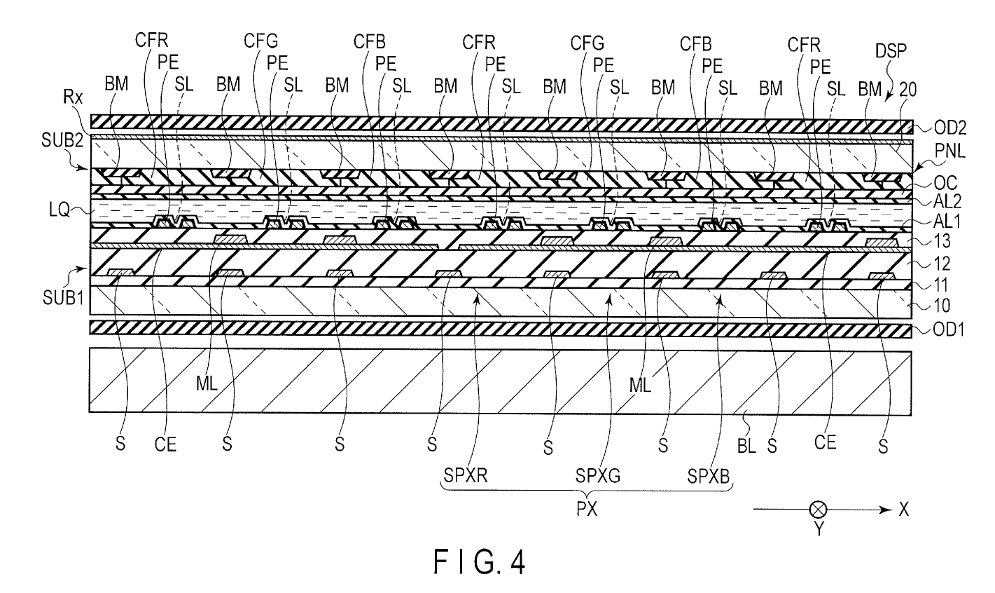

FIG. 4 is a cross-sectional view which schematically and partly shows the structure of the liquid crystal display device DSP. The liquid crystal display device DSP includes a first optical element OD1 and second optical element OD2 in addition to the above-described liquid crystal display panel PNL and backlight unit BL. The liquid crystal display panel PNL depicted in the Figure has a structure corresponding to a fringe field switching (FFS) mode as its display mode; however, no limitation is intended thereby, and the liquid crystal display panel PNL may have a structure which corresponds to another display mode.

The liquid crystal display panel PNL includes the first substrate SUB1, second substrate SUB2, and liquid crystal layer LQ. The first substrate SUB1 and the second substrate SUB2 are attached to each other with a certain cell gap formed therebetween. The liquid crystal layer LQ is held in the cell gap between the first substrate SUB1 and the second substrate SUB2.

The first substrate SUB1 is formed based on a transmissive first insulating substrate 10 such as a glass substrate or a resin substrate. The first substrate SUB1 includes the source lines S, common electrodes CE, pixel electrode PE, first insulating film 11, second insulating film 12, third insulating film 13, and first alignment film AL1 on the surface of the first insulating substrate 10 at the side opposed to the second substrate SUB2.

The first insulating film 11 is disposed on the first insulating substrate 10. Although this is not described in detail, the gate lines G, gate electrode of the switching element, and semiconductor layer are provided between the first insulating substrate 10 and the first insulating film 11. The source lines S are formed on the first insulating film 11. Furthermore, source electrode and drain electrode of the switching element PSW are formed on the first insulating film 11.

The second insulating film 12 is disposed on the source lines S and the first insulating film 11. The common electrode CE is formed on the second insulating film 12. This common electrode CE is formed of a transparent conductive material such as indium tin oxide (ITO) and indium zinc oxide (IZO). In the example depicted, a metal layer ML is formed on the common electrode CE to lower the resistance of the common electrode CE; however, this metal layer ML may be omitted.

The third insulating film 13 is disposed on the common electrodes CE and the second insulating film 12. The pixel electrodes PE are formed on the third insulating film 13. Each pixel electrode PE is disposed between adjacent source lines S to be opposed to the common electrode CE. Furthermore, each pixel electrode has a slit SL at a position to be opposed to the common electrode CE. This pixel electrode PE is formed of a transparent conductive material such as ITO or IZO. The first alignment film AL1 covers the pixels electrodes and the third insulating film 13.

On the other hand, the second substrate SUB2 is formed based on a transmissive second insulating substrate 20 such as a glass substrate or a resin substrate. The second substrate SUB2 includes black matrixes BM, color filters CFR, CFG, and CFB, overcoat layer OC, and second alignment film AL2 on the surface of the second insulating substrate 20 at the side opposed to the first substrate SUB1.

The black matrixes BM are formed on the inner surface of the second insulating substrate 20 to define the subpixels SPX one another.

Each of color filters CFR, CFG, and CFB is formed on the inner surface of the second insulating substrate 20 and partly overlaps the black matrix BM. Color filter CFR is a red filter which is disposed to correspond to a red subpixel SPXR and is formed of a red resin material. Color filter CFG is a green filter which is disposed to correspond to a green subpixel SPXG and is formed of a green resin material. Color filter CFB is a blue filter which is disposed to correspond to a blue subpixel SPXB and is formed of a blue resin material. In the example depicted, a unit pixel PX is composed of subpixels SPXR, SPXG, and SPXB those correspond to red, green, and blue, respectively. However, the unit pixel PX is not limited to a combination of the above-mentioned three subpixels SPXR, SPXG, and SPXB. For example, the unit pixel PX may be composed of four subpixels SPX including a white subpixel SPXW in addition to the subpixel SPXR, SPXG, and SPXB. In that case, a white or transparent filter may be disposed to correspond to the subpixel SPXW, or a color filter corresponding to the subpixel SPXW may be omitted. Or, a subpixel of a different color such as yellow may be disposed instead of a white subpixel.

The overcoat layer OC covers color filters CFR, CFG, and CFB. The overcoat layer OC is formed of a transparent resin material. The second alignment film AL2 covers the overcoat layer OC.

The detection electrode Rx is formed on the outer surface of the second insulating substrate 20. That is, in the present embodiment, the detection surface is disposed on the outer surface of the second insulating substrate 20. The detailed structure of the detection electrode Rx is described later.

As can be clearly understood from FIGS. 1 to 4, both the detection electrode Rx and the common electrode CE are disposed in different layers in the normal direction of the display area DA, and they are opposed to each other with dielectrics intervening therebetween such as third insulating film 13, first alignment film AL1, liquid crystal layer LQ, second alignment film AL2, overcoat layer OC, color filters CFR, CFG, and CFB, and second insulating substrate 20.

The first optical element OD1 is interposed between the first insulating substrate 10 and the backlight unit BL. The second optical element OD2 is disposed above the detection electrode Rx. Each of the first optical element OD1 and the second optical element OD2 includes at least a polarizer and may include a retardation film if necessary.

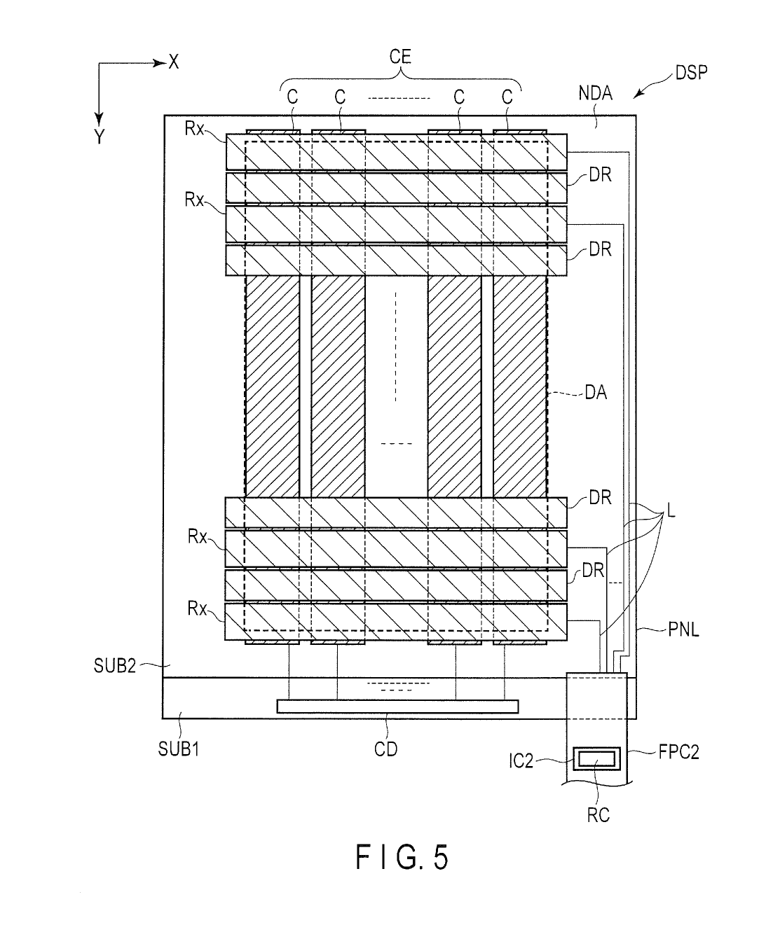

Now, the capacitive sensor SE mounted on the liquid crystal display device DSP of the present embodiment is explained. FIG. 5 is a plan view which schematically shows a structural example of the sensor SE. In the example depicted, the sensor SE is composed of the common electrode CE of the first substrate SUB1 and the detection electrodes Rx of the second substrate SUB2. That is, the common electrode CE functions as an electrode for display and also as an electrode for sensor driving.

The liquid crystal display panel PNL includes lead lines L in addition to the common electrode CE and the detection electrodes Rx. The common electrode CE and the detection electrodes Rx are disposed within the display area AA. In the example depicted, the common electrode CE includes a plurality of divisional electrodes C. Divisional electrodes C are extended substantially linearly in direction Y and arranged at intervals in direction X within the display area DA. The detection electrodes Rx are extended substantially linearly in direction X and arranged at intervals in direction Y within the display area DA. That is, the detection electrodes Rx are extended to cross the divisional electrodes C. As mentioned above, the common electrode CE and the detection electrodes Rx are opposed to each other with various dielectrics intervening therebetween.

Now, a display driving operation performed to display images in the liquid crystal display device DSP in the above-described FFS mode is described. First, the off-state where no voltage is applied to the liquid crystal layer LQ is explained. The off-state is a state where a potential difference is not formed between the pixel electrode PE and the common electrode CE. In this off-state, liquid crystal molecules in the liquid crystal layer LQ are aligned in the same orientation within X-Y plane as their initial alignment by the alignment restriction force between the first alignment film AL1 and the second alignment film AL2. The light from the backlight unit BL partly transmits the polarizer of the first optical element OD1 and is incident on the liquid crystal display panel PNL. The light incident on the liquid crystal display panel PNL is linear polarization which is orthogonal to an absorption axis of the polarizer. The state of the linear polarization does not substantially change when passing though the liquid crystal display panel PNL in the off-state. Thus, the majority of the linear polarization which have passed through the liquid crystal display panel PNL are absorbed by the polarizer of the second optical element OD2 (black display).

Next, the on-state where a voltage is applied to the liquid crystal layer LQ is explained. The on-state is a state where a potential difference is formed between the pixel electrode PE and the common electrode CE. That is, common driving signals are supplied to the common electrode CE to set it to the common potential. Furthermore, image signals to form the potential difference with respect to the common potential are supplied to the pixel electrode PE. Consequently, a fringe field is generated between the pixel electrode PE and the common electrode CE in the on-state. In this on-state, the liquid crystal molecules are aligned in the orientation different from that of the initial alignment within X-Y plane. In the on-state, the linear polarization which is orthogonal to the absorption axis of the polarizer of the first optical element OD1 is incident on the liquid crystal display panel PNL and its polarization state changes depending on the alignment of the liquid crystal molecules when passing through the liquid crystal layer LQ. Thus, in the on-state, at least part of the light which has passed through the liquid crystal layer LQ transmits the polarizer of the second optical element OD2 (white display). With this structure, a normally black mode is achieved.

The number, size, and shape of the divisional electrodes C are not limited specifically and can be changed arbitrarily. Furthermore, the divisional electrodes C may be arranged at intervals in direction Y and extended substantially linearly in direction X. Moreover, the common electrode CE is not necessarily divided and may be a single plate electrode formed continuously within the display area DA.

Within the detection surface on which the detection electrodes Rx are disposed, dummy electrodes DR are provided between adjacent detection electrodes Rx. The dummy electrodes DR are extended substantially linearly in direction X similarly to the detection electrodes Rx. These dummy electrodes DR are not connected with the lines such as lead lines L, and are in the electrically floating state. The dummy electrodes DR do not play any role in detection of a contact or approach of an object. That is, the dummy electrodes DR are not necessary from the object detection standpoint. However, without such dummy electrodes DR, the screen display of the liquid crystal display panel PNL will be optically nonuniform. Therefore, the dummy electrodes DR should preferably be provided.

The lead lines L are disposed within the non-display area NDA and are electrically connected to the detection electrodes Rx one to one. Each of the lead lines L outputs a sensor output value from its corresponding detection electrode Rx. The lead lines L are disposed in the second substrate SUB2 similarly to the detection electrodes Rx, for example.

The liquid crystal display device DSP further includes the common electrode driving circuit CD disposed within the non-display area NDA. Each of the divisional electrodes C is electrically connected to the common electrode driving circuit CD. The common electrode driving circuit CD selectively supplies common driving signals (first driving signals) to drive the subpixels SPX and sensor driving signals (second driving signals) to drive the sensor SE to the divisional electrodes C. For example, the common electrode driving circuit CD supplies the common driving signals in a display driving time to display images on the display area DA and supplies sensor driving signals in a sensor driving time to detect a contact or approach of an object to the detection surface.

The flexible printed circuit FPC2 is electrically connected to each of the lead lines L. A detection circuit RC is accommodated in, for example, the driving IC chip IC2. The detection circuit RC detects a contact or approach of an object to the liquid crystal display device DSP base on the sensor output value from the detection electrodes Rx. Furthermore, the detection circuit RC can detect positional data of the position to which the object contacts or approaches. The detection circuit RC may be accommodated in the control module CM instead.

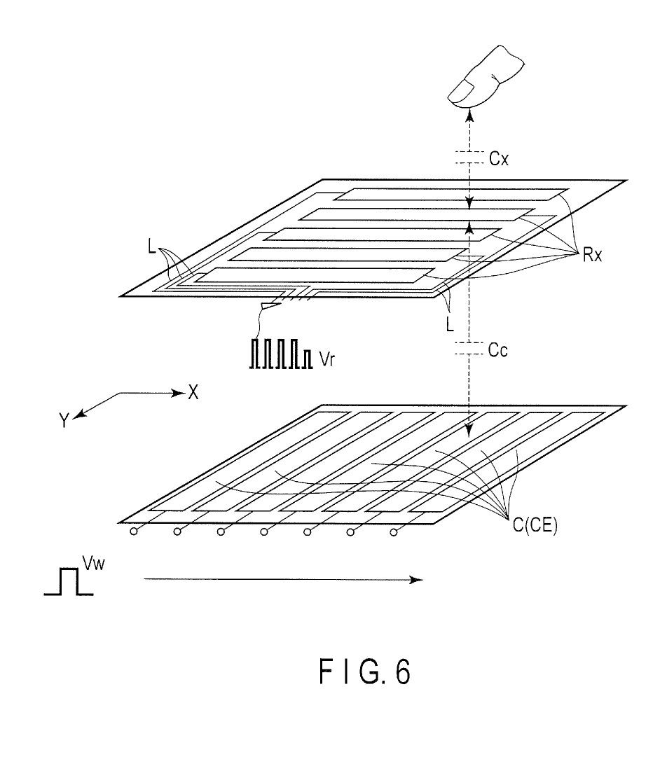

Now, the specific operation performed in detecting a contact or approach of an object by the liquid crystal display device DSP is explained with reference to FIG. 6. A capacitance Cc exists between the divisional electrodes C and the detection electrodes Rx. The common electrode driving circuit CD supplies pulse-shaped sensor driving signals Vw to each of the divisional electrodes C at certain periods. In the example depicted, a finger of a user is given to be close to a crossing point of a particular detection electrode Rx and a particular divisional electrode C. The finger close to the detection electrode Rx generates a capacitance Cx. When the pulse-shaped sensor driving signals Vw are supplied to the divisional electrodes C, the particular detection electrode Rx shows a pulse-shaped sensor output value Vr of which level is less than those are obtained from the other detection electrodes. This sensor output value Vr is supplied to the detection circuit RC through the lead lines L.

The detection circuit RC detects two-dimensional positional data of the finger within the X-Y plane (detection surface) based on the timing when the sensor driving signals Vw are supplied to the divisional electrodes C and the sensor output value Vr from each detection electrode Rx. Furthermore, capacitance Cx varies between the states where the finger is close to the detection electrode Rx and where the finger is distant from the detection electrode Rx. Thus, the level of the sensor output value Vr varies between the states where the finger is close to the detection electrode Rx and where the finger is distant from the detection electrode Rx. Using this mechanism, the detection circuit RC may detect the proximity of the finger with respect to the sensor SE (distance between the finger and the sensor SE in the normal direction) based on the level of the sensor output value Vr.

The above-explained detection method of the sensor SE is referred to as a mutual-capacitive method or a mutual-capacitive sensing method. The detection method applied to the sensor SE is not limited to such a mutual-capacitive sensing method and may be other methods. For example, the following methods may be applied to the sensor SE: a self-capacitive method, a self-capacitive sensing method, and the like.

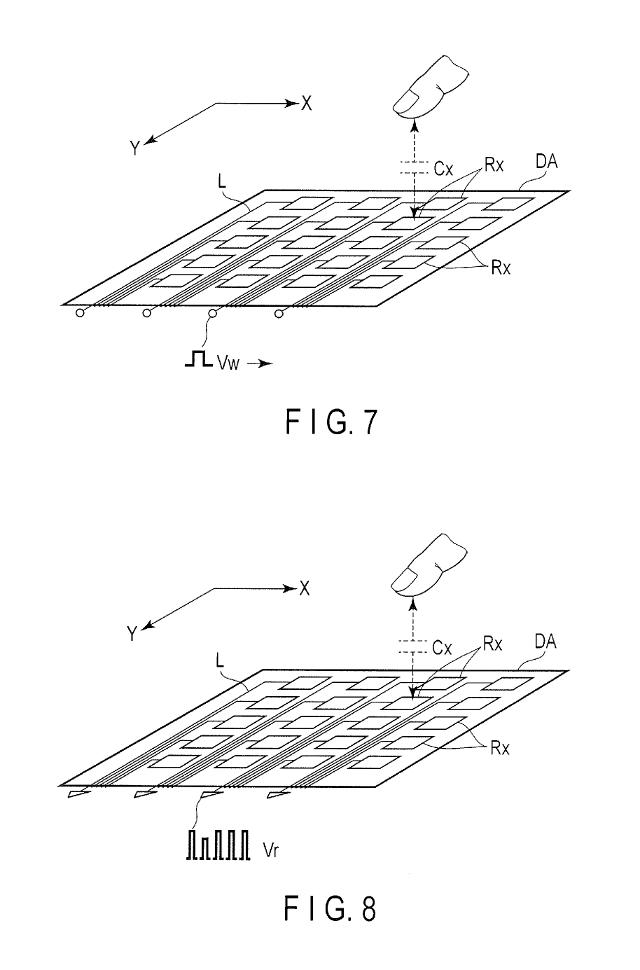

FIGS. 7 and 8 show the specific operation performed in detecting a contact or approach of an object by the liquid crystal display device DSP using the self-capacitive sensing method. In FIGS. 7 and 8, the detection electrodes Rx are formed as islands and arranged in a matrix along directions X and Y on the display area DA. The lead lines L are electrically connected to the detection electrodes Rx one to one at their ends. The other ends of the lead lines L are, as in the example shown in FIG. 5, connected to the flexible printed circuit FPC2 including the driving IC chip IC2 in which the detection circuit RC is accommodated. In the example depicted, a finger of a user is given to be close to a particular detection electrode Rx. The finger close to the detection electrode Rx generates a capacitance Cx.

As shown in FIG. 7, the detection circuit RC supplies pulse-shaped sensor driving signals Vw (driving voltage) to each of the detection electrodes Rx at certain periods. By the sensor driving signals Vw, each detection electrode Rx itself is charged.

After the sensor driving signal Vw supply, the detection circuit RC reads the sensor output value Vr from each of the detection electrodes Rx as shown in FIG. 8. The sensor output value Vr corresponds to, for example, the charge on each detection electrode Rx itself. In the detection electrodes Rx arranged on the X-Y plane (detection surface), the sensor output value Vr read from the detection electrode Rx at which a capacitance Cx is generated between itself and the finger is different from the sensor output values Vr read from the other detection electrodes Rx. Therefore, the detection circuit RC can detect the two-dimensional positional data of the finger on the X-Y plane based on the sensor output values Vr of the detection electrodes Rx.

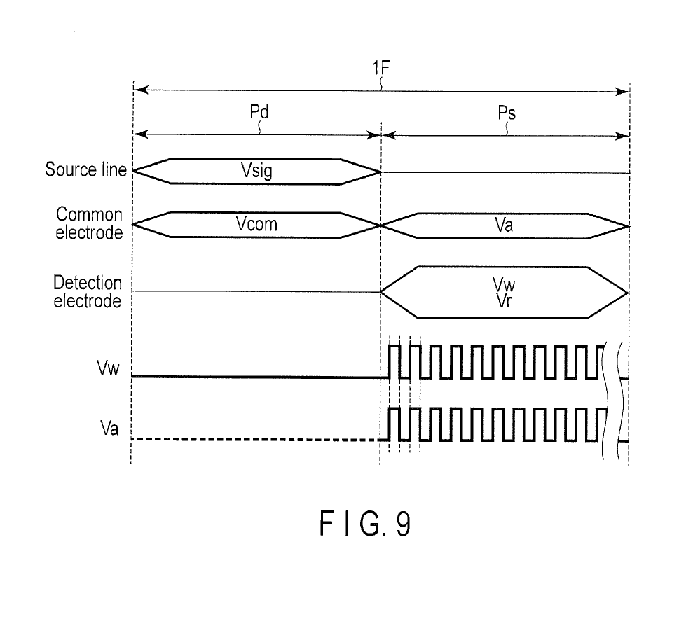

Now, a specific example of how to drive the sensor SE in the self-capacitive sensing method is explained with reference to FIG. 9. In the example depicted, a display operation performed in a display operation period Pd and a detection operation of input positional data performed in a detection operation period Ps within one frame (1F) period. The detection operation period Ps is a period excluded from the display operation period Pd and is, for example, a blanking period in which the display operation halts.

In the display operation period Pd, the gate line driving circuit GD supplies control signals to the gate lines G, the source line driving circuit SD supplies image signals Vsig to the source lines S, and the common electrode driving circuit CD supplies common driving signals Vcom (common voltage) to the common electrode CE (divisional electrodes C) for the drive of the liquid crystal display panel PNL.

In the detection operation period Ps, the input of control signal, image signal Vsig, and common driving signal Vcom to the liquid crystal display panel PNL are stopped and the sensor SE is driven. When driving the sensor SE, the detection circuit RC supplies sensor driving signals Vw to the detection electrodes Rx, reads the sensor output values Vr indicative of changes in capacitance in the detection electrodes Rx, and operates the input positional data based on the sensor output values Vr. In this detection operation period Rs, the common electrode driving circuit CD supplies potential adjustment signals Va, of which waveform is the same as that of the sensor driving signals Vw supplied to the detection electrodes Rx, to the common electrode CE in synchronization with sensor driving signals Vw. Here, the same waveform means that the sensor driving signals Vw and the potential adjustment signals are the same with respect to their phase, amplitude, and period. By supplying such potential adjustment signals Va to the common electrode CE, a stray capacitance (parasitic capacitance) between the detection electrodes Rx and the common electrode CE can be removed and the operation of the input positional data can be performed accurately.

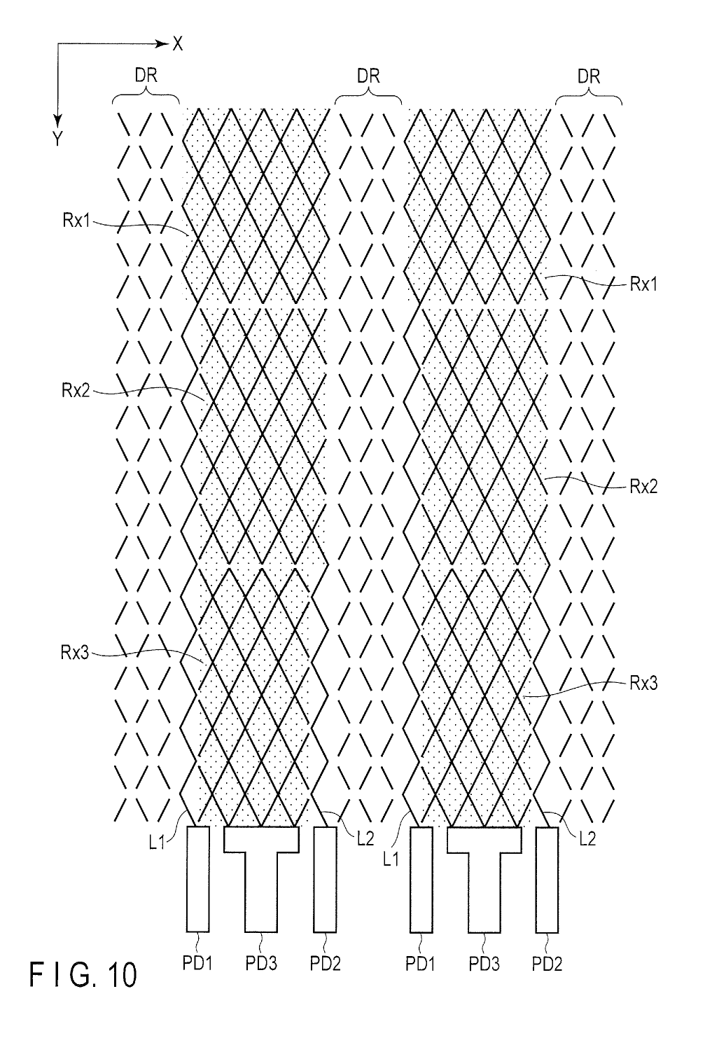

FIG. 10 is a view which schematically shows an example of the detection electrodes Rx arranged in a matrix. In the example depicted, detection electrodes Rx1, Rx2, and Rx3 are aligned in direction Y. Detection electrodes Rx1 are connected to pads PD1 through lead lines L1. Detection electrodes Rx2 are connected to pads PD2 through lead lines L2. Detection electrodes Rx3 are directly connected to pads PD3. Pads PD1 to PD3 are connected to flexible printed circuit FPC2. Detection electrodes Rx1 to Rx3 are, for example, formed in a mesh structure of metal material line fragments (line fragments T described later) connected to each other. However, the structure of detection electrodes Rx1 to Rx3 is not limited to that shown in FIG. 10 and may be replaced with one of various structures including the structures described in the following example.

In direction X, detection electrodes Rx1 to Rx3, lead lines L1 and L2, and pads PD1 to PD3 are aligned at certain intervals. Between a set of detection electrodes Rx1 to Rx3 and its adjacent sets of detection electrodes Rx1 to Rx3 in direction X, dummy electrodes DR are disposed. The dummy electrodes DR are formed in a mesh structure of line fragments as in detection electrodes Rx1 to Rx3. However, the line fragments of the dummy electrode DR are not connected to each other or connected to any of detection electrodes Rx1 to Rx3, lead lines L1 and L2, and pads PD1 to PD3. That is, the line fragments of the dummy electrode DR are in the electrically floating state. By arranging the detection electrodes Rx and the dummy electrodes DR which are alike in shape, the screen display of the liquid crystal display panel PNL can be maintained optically uniform.

Next, the detailed structure of the detection electrodes Rx is explained. Note that the structure of the detection electrodes Rx can be applied to various detection methods including the above-described mutual-capacitive sensing method, self-capacitive sensing method, and the like.

The detection electrodes Rx have an electrode pattern (electrode pattern PT described later) of conductive line fragments (line fragments T described later) combined together. The line fragment is formed of a metal material such as aluminum (Al), titan (Ti), silver (Ag), molybdenum (Mo), tungsten (W), copper (Cu), and chrome (Cr), or of an alloy, oxide, and nitride including such a material. The width of the line fragment should preferably be set to fall within such a range that does not decrease the transmissivity of each pixel while maintaining a certain resistance to a break. For example, the width may be set to fall within a range between 3 μm and 10 μm inclusive. For example, the line fragment may also be called as a conductive fragment, a metal fragment, a thin fragment, a unit fragment, a conductive line, a metal line, a thin line, or a unit line.

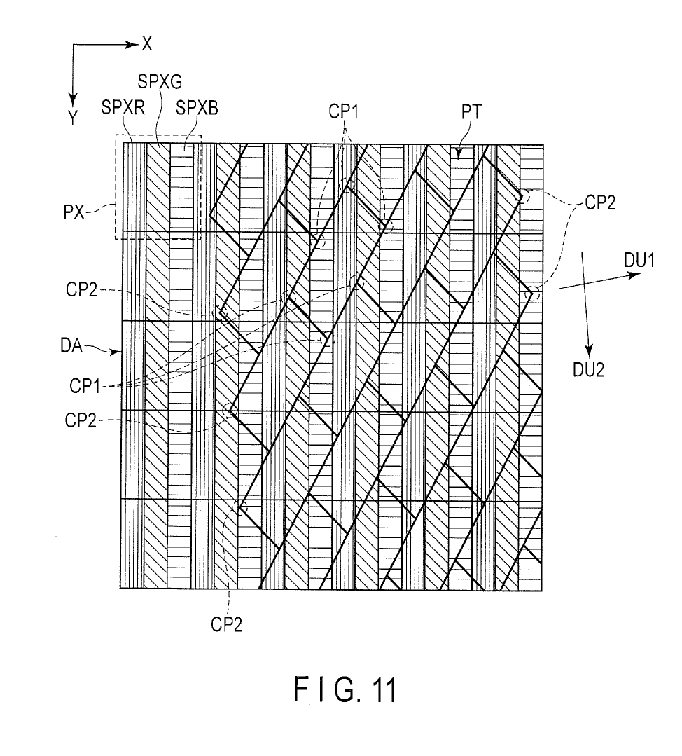

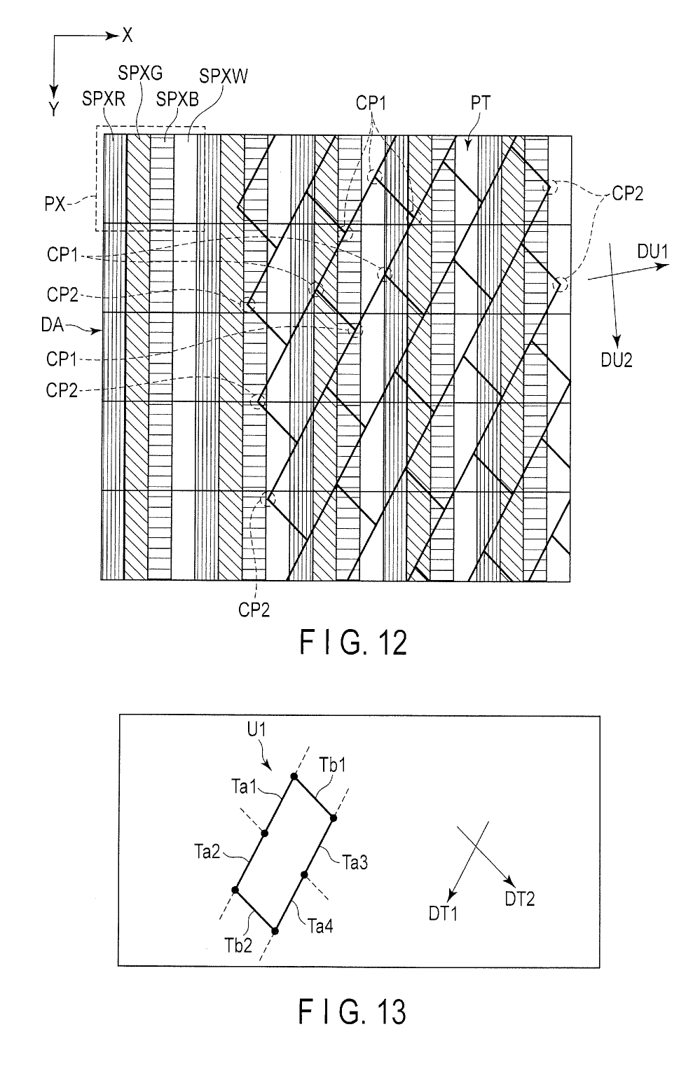

Now, an example of a pixel arrangement and an electrode pattern of detection electrodes Rx within the display area DA are explained. FIGS. 11 and 12 schematically show unit pixels PX and electrode pattern PT of detection electrodes Rx within the display area DA in part.

In FIGS. 11 and 12, unit pixels PX are arranged in a matrix in both directions X and Y. In FIG. 11, each unit pixel PX is composed of red, green, and blue subpixels SPXR, SPXG, and SPXB. Red subpixels SPXR, green subpixels SPXG, and blue subpixels SPXB are aligned in direction Y, respectively. In FIG. 12, each unit pixel PX is composed of red, green, blue, and white subpixels SPXR, SPXG, SPXB, and SPXW. Red subpixels SPXR, green subpixels SPXG, blue subpixels SPXB, and white subpixels SPXW are aligned in direction Y, respectively.

The electrode pattern PT of the present embodiment includes a plurality of unit patterns U1 shown in FIG. 13. Unit pattern U1 has an outline defined by (or closed by) line fragments Ta (Ta1, Ta2, Ta3, and Ta4) extending linearly in first extension direction DT1 and line fragments Tb (Tb1 and Tb2) extending linearly in second extension direction DT2 which crosses the first extension direction DT1. In the example depicted, a counterclockwise angle from first extension direction DT1 to second extension direction DT2 is acute, and unit pattern U1 is a parallelogram. However, an angle formed by first and second extension directions DT1 and DT2 may be obtuse or may be right-angled.

In the examples of FIGS. 11 and 12, the electrode pattern PT is composed of unit patterns U1 arranged along first arrangement direction DU1 and second arrangement direction DU2 crossing directions X and Y, respectively. Note that either first arrangement direction DU1 or second arrangement direction DU2 may match direction X or direction Y, or first and second arrangement directions DU1 and DU2 may match directions X and Y, respectively.

In this electrode pattern PT, the outlines of two adjacent unit patterns U1 are formed to share a single line fragment T. For example, in the two unit patterns U1 arranged consecutively in first arrangement direction DU1, the outlines of these two unit patterns U1 are formed such that one line fragment Ta disposed at their boundary constitutes line fragment Ta2 of one unit pattern U1 and also line fragment Ta3 of the other unit pattern U1. Furthermore, in the two unit patterns U1 arranged consecutively in second arrangement direction DU2, the outlines of these two unit patterns U1 are formed such that one line fragment Ta disposed at their boundary constitutes line fragment Ta1 and also line fragment Ta4 of the other unit pattern U1.

The electrode pattern PT includes a number of connection points at which the ends of three line fragments T are connected together. For example, as shown in FIGS. 11 and 12, two line fragments Ta and one line fragment Tb are connected together at connection points CP1 formed at each end of line fragment Ta and line fragment Tb shared by adjacent unit patterns U1.

Two line fragments Ta are connected linearly and one line fragment Tb is connected to these line fragments Ta at any angle except 180° at connection points CP1. Therefore, three line fragments T diverge in substantially a T-shape from a connection point CP1.

At a connection point CP1 shown in FIGS. 11 and 12, outlines of three unit patterns U1 contact each other as well. That is, at a connection point CP1, the ends of three line fragments T (two line fragments Ta and one line fragment Tb) included in three unit patterns U1 respectively are connected together.

The electrode pattern PT shown in FIGS. 11 and 12 further includes, in addition to connection points CP1 from which line fragments T diverge in three directions, connection points CP2 from which line fragments T divides in two directions. Connection point CP2 appears at one end of line fragment Ta or line fragment Tb which is not shared by a plurality of unit patterns U1, and one line fragment Ta and one line fragment Tb are connected at their ends at connection point CP2. In the electrode pattern PT of the present embodiment, a single connection point does not bring together four or more line fragments T.

FIGS. 11 and 12 schematically show the display area DA and the electrode pattern PT of a single detection electrode Rx in part for the explanation of the electrode pattern PT. In the realization, as in FIGS. 5, 7, 8, and 10, detection electrodes Rx including the electrode pattern PT are layered one after another within the display area DA and a contact or approach of a finger or the like can be detected at any position within the display area DA. Furthermore, although this is omitted in FIGS. 11 and 12, dummy electrodes DR are provided between adjacent detection electrodes Rx as in FIGS. 5 and 10.

For example, if detection electrodes Rx extend in direction X and are arranged in direction Y as shown in FIG. 5, such detection electrodes Rx may have the electrode pattern PT shown in FIGS. 11 and 12 cut in stripes along direction X. Similarly, if detection electrodes Rx extend in direction Y and are arranged in direction X, such detection electrodes Rx may have the electrode pattern PT shown in FIGS. 11 and 12 in stripes along direction Y. In those cases, the electrode pattern PT may be cut in such a manner that connection points CP2 shown in FIGS. 11 and 12 are not formed.

Furthermore, if detection electrodes Rx are formed in islands as shown in FIG. 7, such detection electrodes Rx may have the electrode pattern PT shown in FIGS. 11 and 12 cut in pieces along directions X and Y. In that case, the electrode pattern PT may be cut in such a manner that connection points CP2 shown in FIGS. 11 and 12 are not formed.

For example, if line fragment T is formed of a metal material having low transmissivity, the light from the display area DA is blocked at the position where the line fragment T is. Especially, the light is largely blocked at a connection point where several line fragments T are closely connected together.

A mesh electrode pattern in which a plurality of conductive thin lines extending linearly are crossed is conventionally used. In such a mesh electrode pattern, two conductive thin lines cross at a crossing point to diverge in four directions (in other words, four line fragments are connected together at a point), and such four-way diverging crossing points are formed linearly on each conductive thin lines. Thus, the conductive thin lines are connected closely at the crossing points. Consequently, the brightness is weakened at the crossing points arranged linearly on the display area and a contrast is caused. Due to the interference between the contrast and each subpixel, highly-visible moiré occurs easily.

On the other hand, at a connection point in the electrode pattern PT of the present embodiment, line fragments T diverge in three directions and thus, the present embodiment has a ratio of line fragments T (conductive thin lines) per unit area less than that of the above case using the four-way diverging crossing points. Therefore, even when moiré occurs because of a contrast on such connection points and subpixels SPX, the moiré is less visible than that of the above-mentioned four-way branching crossing points.

Furthermore, as in the present embodiment, if the electrode pattern PT is composed of the unit patterns U defined by line fragments T and adjacent unit patterns U therein share at least one line fragment T, the detection electrodes Rx does not break easily. That is, in such an electrode pattern PT, even if a break occurs at one point between adjacent unit patterns U, an electrical connection in the line fragments T adjacent to this break point can be maintained by other routes. Therefore, the present embodiment can increase the reliability of sensing function of the liquid crystal display device DSP.

Furthermore, in this embodiment, the detection electrodes Rx and the sensor driving electrode (common electrode CE) those are components of the sensor SE are disposed on different layers with dielectrics interposed therebetween. If the detection electrodes Rx and the sensor driving electrode were provided with the same layer, an electric corrosion would occur between the detection electrodes Rx and the sensor driving electrode. The structure of the present embodiment can prevent such an electric corrosion.

Furthermore, in the present embodiment, the common electrode disposed inside the liquid crystal display panel PNL is used for both the electrode for display and the electrode for sensor driving in the above-described mutual-capacitive sensing method and thus, there is no need of a sensor driving electrode for sensing purpose only disposed in the liquid crystal display device DSP. If such a sensor driving electrode for sensing purpose only is provided therein, moiré may occur due to the interference between the sensor driving electrode and the detection electrodes Rx or the display area DA. The present embodiment can prevent such moiré. Furthermore, in the present embodiment, the common electrode CE is formed of a transparent conductive material and thus, moiré due to the interference between the common electrode CE and the display area DA or the detection electrodes Rx can be prevented or suppressed.

In addition to the above, various favorable advantages can be achieved by the present embodiment.

The shape of the electrode pattern PT is not limited to the model depicted in FIGS. 11 and 12. Hereinafter, other embodiments of the electrode pattern PT are exemplified. Unless otherwise specified, the structure of the first embodiment is adopted therein.

### Second Embodiment

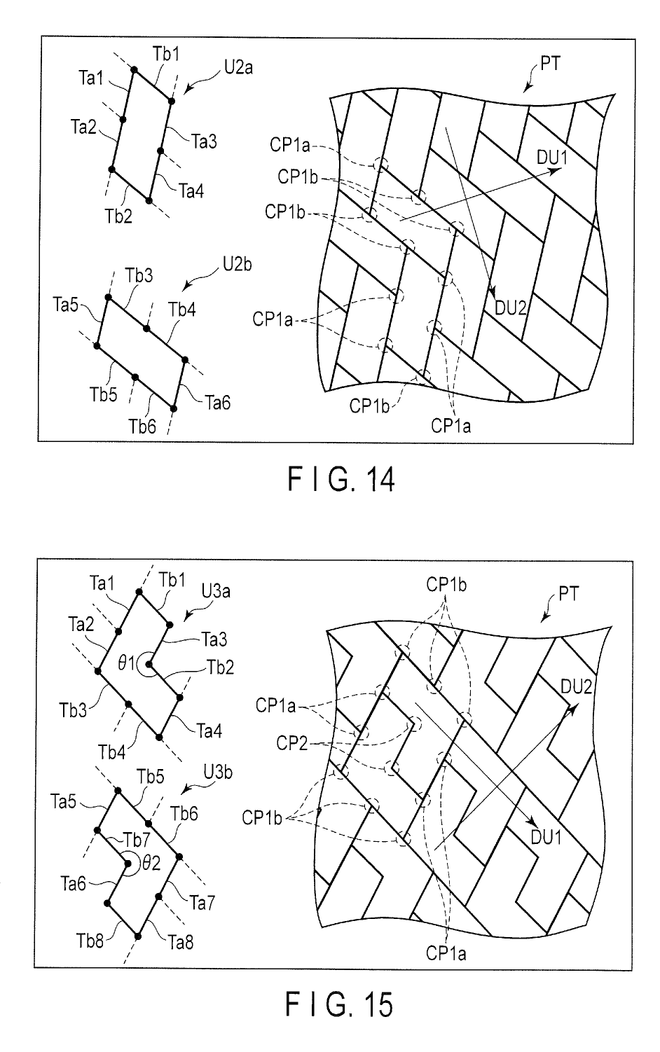

FIG. 14 schematically shows a part of the electrode pattern PT of the second embodiment. Unit patterns U2a and U2b are shown at the left of FIG. 14. The electrode pattern PT is a combination of unit patterns U2a and U2b. Specifically, in this electrode pattern PT, unit patterns U2a and U2b both extending in first arrangement direction DU1 are arranged alternately in second arrangement direction DU2. Unit pattern U2a is a parallelogram defined by (or closed by) line fragments Ta1, Ta2, Ta3, Ta4, Tb1, and Tb2. Unit pattern U2b is a parallelogram defined by (or closed by) line fragments Ta5, Ta6, Tb3, Tb4, Tb5, and Tb6. Unit patterns U2a and U2b are symmetrical with respect to the axis along first arrangement direction DU1 and the axis along second arrangement direction DU2.

In this electrode pattern PT, the outlines of two adjacent unit patterns U2a, the outlines of two adjacent unit patterns U2b, and the outlines of adjacent unit patterns U2a and U2b are formed to share one line fragment T. For example, in the two unit patterns U2a arranged consecutively in first arrangement direction DU1, the outlines of these two unit patterns U2a are formed such that one line fragment Ta disposed at their boundary constitutes line fragment Ta2 of one unit pattern U2a and line fragment Ta3 of the other unit pattern U2a.

Furthermore, for example, in the two unit patterns U2b arranged consecutively in first arrangement direction DU1, the outlines of these two unit patterns U2b are formed such that one line fragment Tb disposed at their boundary constitutes line fragment Tb4 of one unit pattern U2b and also line fragment Tb5 of the other unit pattern U2b.

One unit pattern U2a is adjacent to four unit patterns U2b. The outline of this unit pattern U2a is formed such that its line fragments Ta1, Ta4, Tb1, and Tb2 are shared by the outlines of the four unit patterns U2b.

Furthermore, one unit pattern U2b is adjacent to four unit patterns U2a. The outline of this unit pattern U2b is formed such that its line fragments Ta5, Ta6, Tb3, and Tb6 are shared by the outlines of the four unit patterns U2a.

The electrode pattern PT includes a number of connection points each of which bring together the ends of three line fragments T. For example, as shown in FIG. 14, connection point CP1a at which two line fragments Ta and one line fragment Tb are connected together and connection point CP1b at which one line fragment Ta and two line fragments Tb are connected together are formed at the ends of line fragments Ta and Tb which are shared by two adjacent unit patterns U2a, two adjacent unit patterns U2b, and adjacent unit patterns U2a and U2b.

At each connection point CP1a or CP1b, two line fragments T are connected to each other linearly and one line fragment T is connected to these two line fragments T at any angle except 180°. Therefore, three line fragments T form substantially a T-shape defined by connection points CP1a and CP1b.

For example, one connection point CP1a involves two line fragments Ta constituting line fragment Ta2 of unit pattern U2a and line fragment Ta5 of unit pattern U2b and one line fragment Tb constituting line fragment Tb2 of unit pattern U2a and line fragment Tb3 of unit pattern U2b.

For example, one connection point CP1b involves one line fragment Ta constituting line fragment Ta4 of unit pattern U2a and line fragment Ta5 of unit pattern U2b and two line fragments Tb constituting line fragment Tb2 of unit pattern U2a and line fragment Tb5 of unit pattern U2b.

At connection points CP1a and CP1b in FIG. 14, two unit patterns U2a and one unit pattern U2b, or one unit pattern U2a and two unit patterns U2b are connected together.

In FIG. 14, as a part of the electrode pattern PT, only the connection points at which three line fragments T are connected together are depicted; however, the number of line fragments T is not limited to three and the electrode pattern PT may include connection points at which line fragments T of any number except three are connected together. For example, as in FIGS. 11 and 12, at an end of line fragment Ta or Tb which is not shared by a plurality of unit patterns U2a and U2b on the edge of the electrode pattern PT, there will be a two-way diverging connection point at which one line fragment Ta and one line fragment Tb are connected to each other.

Furthermore, in the example of FIG. 14, line fragments Ta and Tb are depicted to connect to each other at an acute or obtuse angle at the connection point; however, line fragments Ta and Tb may connect to each other at right angles.

### Third Embodiment

FIG. 15 schematically shows a part of the electrode pattern PT of the third embodiment. Unit patterns U3a and U3b are shown at the left of FIG. 15. The electrode pattern PT is a combination of unit patterns U3a and U3b. Specifically, in this electrode pattern PT, unit patterns U3a and U3b both extending in first arrangement direction DU1 are arranged alternately in second arrangement direction DU2. Unit pattern U3a is a hexagon defined by (or closed by) line fragments Ta1, Ta2, Ta3, Ta4, Tb1, Tb2, Tb3, and Tb4. Unit pattern U3b is a hexagon defined by (or closed by) line fragments Ta5, Ta6, Ta7, Ta8, Tb5, Tb6, Tb7, and Tb8. Unit patterns U3a and U3b are symmetrical with respect to a predetermined axis. Interior angle θ1 formed by line fragments Ta3 and Tb2 of unit pattern U3a and interior angle θ2 formed by line fragments Ta6 and Tb7 of unit pattern U3b are both greater than 180° (θ1 and θ2>180°).

In this electrode pattern PT, the outlines of two adjacent unit patterns U3a, the outlines of two adjacent unit patterns U3b, and the outlines of adjacent unit patterns U3a and U3b are formed to share at least one line fragment T. For example, in the two unit patterns U3a arranged consecutively in first arrangement direction DU1, the outlines of these two unit patterns U3a are formed such that one line fragment Ta disposed at their boundary constitutes line fragment Ta2 of one unit pattern U3a and line fragment Ta4 of the other unit pattern U3a.

Furthermore, for example, in the two unit patterns U3b arranged consecutively in first arrangement direction DU1, the outlines of these two unit patterns U3b are formed such that one line fragment Ta disposed at their boundary constitutes line fragment Ta5 of one unit pattern U3b and also line fragment Ta7 of the other unit pattern U3b.

One unit pattern U3a is adjacent to four unit patterns U3b. The outline of this unit pattern U3a is formed such that its line fragments Ta1, Ta3, Tb1, Tb2, Tb3, and Tb4 are shared by the outlines of the four unit patterns U3b.

Furthermore, one unit pattern U3b is adjacent to four unit patterns U3a. The outline of this unit pattern U3b is formed such that its line fragments Ta6, Ta8, Tb5, Tb6, Tb7, and Tb8 are shared by the outlines of the four unit patterns U3a.

The electrode pattern PT includes a number of connection points each of which bring together the ends of three line fragments T. For example, as shown in FIG. 15, connection point CP1a in which two line fragments Ta and one line fragment Tb are connected together and connection point CP1b in which one line fragment Ta and two line fragments Tb are connected together are formed at ends of line fragments Ta and Tb which are shared by two adjacent unit patterns U3a, two adjacent unit patterns U3b, and adjacent unit patterns U3a and U3b.

At each connection point CP1a or CP1b, two line fragments T are connected to each other linearly and one line fragment T is connected to these two line fragments T at any angle except 180°. Therefore, three line fragments T form substantially a T-shape defined by connection points CP1a and CP1b.

For example, one connection point CP1a involves two line fragments Ta constituting line fragment Ta1 of unit pattern U3a and line fragment Ta5 of unit pattern U3b and one line fragment Tb constituting line fragment Tb1 of unit pattern U3a and line fragment Tb7 of unit pattern U3b.

For example, one connection point CP1b involves one line fragment Ta constituting line fragment Ta5 of unit pattern U3b and two line fragments Tb constituting line fragment Tb3 of unit pattern U3a and line fragment Tb4 of unit pattern U3a (which doubles as line fragment Tb5 of unit pattern U3b).

At connection points CP1a and CP1b in FIG. 15, two unit patterns U3a and one unit pattern U3b, or one unit pattern U3a and two unit patterns U3b are connected together.

As exemplified in FIG. 15, the electrode pattern PT of the present embodiment includes two-way diverging connection point CP2 at which one line fragment Ta and one line fragment Tb are connected to each other. For example, one connection point CP2 of unit pattern U3a involves the ends of line fragment Ta3 and line fragment Tb1.

Furthermore, as in FIGS. 11 and 12, at an end of line fragment Ta or Tb which is not shared by a plurality of unit patterns U3a and U3b on the edge of the electrode pattern PT, there will be a two-way diverging connection point at which one line fragment Ta and one line fragment Tb are connected to each other.

Furthermore, in the example of FIG. 15, line fragments Ta and Tb are depicted to connect to each other at an acute or obtuse angle at the connection point; however, line fragments Ta and Tb may connect to each other at right angles.

### Fourth Embodiment

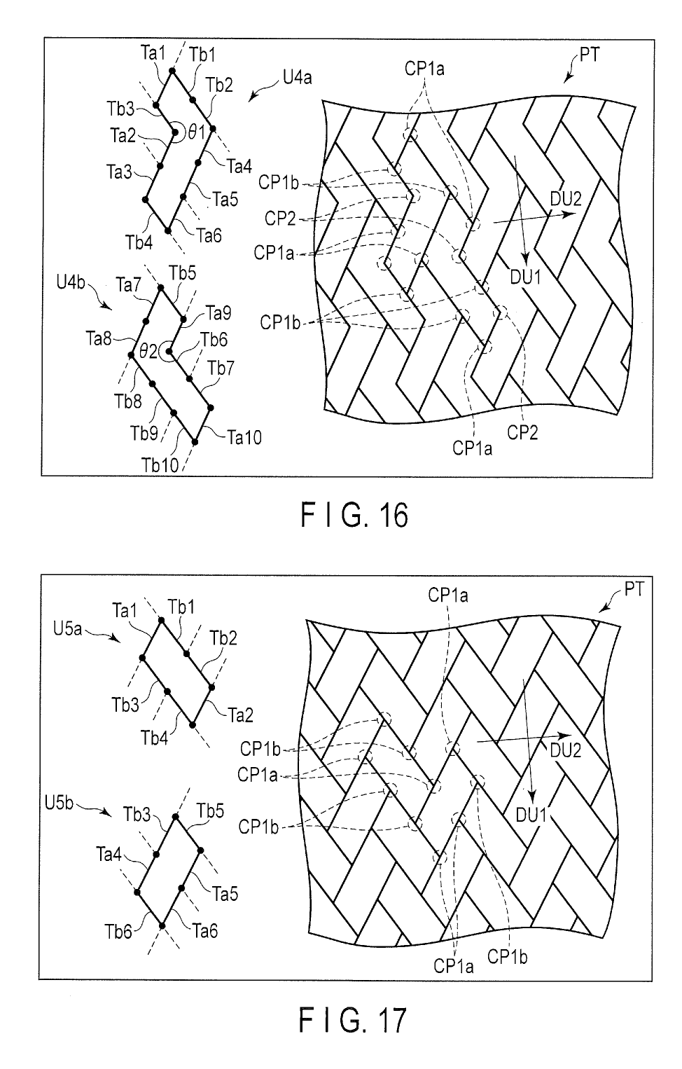

FIG. 16 schematically shows a part of the electrode pattern PT of the fourth embodiment. Unit patterns U4a and U4b are shown at the left of FIG. 16. The electrode pattern PT is a combination of unit patterns U4a and U4b. Specifically, in this electrode pattern PT, unit patterns U4a and U4b both extending in first arrangement direction DU1 are arranged alternately in second arrangement direction DU2. Unit pattern U4a is a hexagon defined by (or closed by) line fragments Ta1, Ta2, Ta3, Ta4, Ta5, Ta6, Tb1, Tb2, Tb3, and Tb4. Unit pattern U4b is a hexagon defined by (or closed by) line fragments Ta7, Ta8, Ta9, Ta10, Tb5, Tb6, Tb7, Tb8, Tb9, and Tb10. Unit patterns U4a and U4b are symmetrical with respect to a predetermined axis. Interior angle θ1 formed by line fragments Ta2 and Tb3 of unit pattern U4a and interior angle θ2 formed by line fragments Ta9 and Tb6 of unit pattern U4b are both greater than 180° (θ1 and θ2>180°).

In this electrode pattern PT, the outlines of two adjacent unit patterns U4a, the outlines of two adjacent unit patterns U4b, and the outlines of adjacent unit patterns U4a and U4b are formed to share at least one line fragment T. For example, in the two unit patterns U4a arranged consecutively in first arrangement direction DU1, the outlines of these two unit patterns U4a are formed such that one line fragment Ta disposed at their boundary constitutes line fragment Ta1 of one unit pattern U4a and line fragment Ta6 of the other unit pattern U4a.

Furthermore, for example, in the two unit patterns U4b arranged consecutively in first arrangement direction DU1, the outlines of these two unit patterns U4b are formed such that one line fragment Tb disposed at their boundary constitutes line fragment Tb5 of one unit pattern U4b and also line fragment Tb10 of the other unit pattern U4b.

One unit pattern U4a is adjacent to four unit patterns U4b. The outline of this unit pattern U4a is formed such that its line fragments Ta2, Ta3, Ta4, Ta5, Tb1, Tb2, Tb3, and Tb4 are shared by the outlines of the four unit patterns U4b.

Furthermore, one unit pattern U4b is adjacent to four unit patterns U4a. The outline of this unit pattern U4b is formed such that its line fragments Ta7, Ta8, Ta9, Ta10, Tb6, Tb7, Tb8, and Tb9 are shared by the outlines of the four unit patterns U4a.

The electrode pattern PT includes a number of connection points each of which bring together the ends of three line fragments T. For example, as shown in FIG. 16, connection point CP1a in which two line fragments Ta and one line fragment Tb are connected together and connection point CP1b in which one line fragment Ta and two line fragments Tb are connected together are formed at ends of line fragments Ta and Tb which are shared by two adjacent unit patterns U4a, two adjacent unit patterns U4b, and adjacent unit patterns U4a and U4b.

At each connection point CP1a or CP1b, two line fragments T are connected to each other linearly and one line fragment T is connected to these two line fragments T at any angle except 180°. Therefore, three line fragments T form substantially a T-shape defined by connection points CP1a and CP1b.

For example, one connection point CP1a involves two line fragments Ta constituting line fragment Ta5 of unit pattern U4a (which doubles as line fragment Ta8 of unit pattern U4b) and line fragment Ta6 of unit pattern U4a and one line fragment Tb constituting line fragment Tb8 of unit pattern U4b.

For example, one connection point CP1b involves one line fragment Ta constituting line fragment Ta4 of unit pattern U4a and line fragment Ta1 of unit pattern U4b and two line fragments Tb constituting line fragment Tb2 of unit pattern U4a and line fragment Tb5 of unit pattern U4a.

At connection points CP1a and CP1b in FIG. 16, two unit patterns U4a and one unit pattern U4b, or one unit pattern U4a and two unit patterns U4b are connected together.

As exemplified in FIG. 16, the electrode pattern PT of the present embodiment includes two-way diverging connection point CP2 at which one line fragment Ta and one line fragment Tb are connected to each other. For example, one connection point CP2 of unit pattern U4a involves the ends of line fragment Ta3 and line fragment Tb4.

Furthermore, as in FIGS. 11 and 12, at an end of line fragment Ta or Tb which is not shared by a plurality of unit patterns U4a and U4b on the edge of the electrode pattern PT, there will be a two-way diverging connection point at which one line fragment Ta and one line fragment Tb are connected to each other.

Furthermore, in the example of FIG. 16, line fragments Ta and Tb are depicted to connect to each other at an acute or obtuse angle at the connection point; however, line fragments Ta and Tb may connect to each other at right angles.

### Fifth Embodiment

FIG. 17 schematically shows a part of the electrode pattern PT of the fifth embodiment. Unit patterns U5a and U5b are shown at the left of FIG. 17. The electrode pattern PT is a combination of unit patterns U5a and U5b. Specifically, in this electrode pattern PT, unit patterns U5a and U5b both extending in first arrangement direction DU1 are arranged alternately in second arrangement direction DU2. Unit pattern U5a is a parallelogram defined by (or closed by) line fragments Ta1, Ta2, Tb1, Tb2, Tb3, and Tb4. Unit pattern U5b is a parallelogram defined by (or closed by) line fragments Ta3, Ta4, Ta5, Ta6, Tb5, and Tb6. Unit patterns U5a and U5b are symmetrical with respect to the axis along first arrangement direction DU1 and the axis along second arrangement direction DU2.

In this electrode pattern PT, the outlines of two adjacent unit patterns U5a, the outlines of two adjacent unit patterns U5b, and the outlines of adjacent unit patterns U5a and U5b are formed to share at least one line fragment T. For example, in the two unit patterns U5a arranged consecutively in first arrangement direction DU1, the outlines of these two unit patterns U5a are formed such that one line fragment Tb disposed at their boundary constitutes line fragment Tb1 of one unit pattern U5a and line fragment Tb4 of the other unit pattern U5a.

Furthermore, for example, in the two unit patterns U5b arranged consecutively in first arrangement direction DU1, the outlines of these two unit patterns U5b are formed such that one line fragment Ta disposed at their boundary constitutes line fragment Ta3 of one unit pattern U5b and also line fragment Ta6 of the other unit pattern U5b.

One unit pattern U5a is adjacent to four unit patterns U5b. The outline of this unit pattern U5a is formed such that its line fragments Ta1, Ta2, Tb2, and Tb3 are shared by the outlines of the four unit patterns U5b.

Furthermore, one unit pattern U5b is adjacent to four unit patterns U5a. The outline of this unit pattern U5b is formed such that its line fragments Ta4, Ta5, Tb5, and Tb6 are shared by the outlines of the four unit patterns U5a.

The electrode pattern PT includes a number of connection points each of which bring together the ends of three line fragments T. For example, as shown in FIG. 17, connection point CP1a in which two line fragments Ta and one line fragment Tb are connected together and connection point CP1b in which one line fragment Ta and two line fragments Tb are connected together are formed at ends of line fragments Ta and Tb which are shared by two adjacent unit patterns U5a, two adjacent unit patterns U5b, and adjacent unit patterns U5a and U5b.

At each connection point CP1a or CP1b, two line fragments T are connected to each other linearly and one line fragment T is connected to these two line fragments T at any angle except 180°. Therefore, three line fragments T form substantially a T-shape defined by connection points CP1a and CP1b.

For example, one connection point CP1a involves two line fragments Ta constituting line fragment Ta3 of unit pattern U5b and line fragment Ta4 of unit pattern U5b (which doubles as line fragment Ta2 of unit pattern U5a) and one line fragment Tb constituting line fragment Tb2 of unit pattern U5a.

For example, one connection point CP1b involves one line fragment Ta constituting line fragment Ta2 of unit pattern U5a and line fragment Ta4 of unit pattern U5b and two line fragments Tb constituting line fragment Tb4 of unit pattern U5a and line fragment Tb6 of unit pattern U5b.

At connection points CP1a and CP1b in FIG. 17, two unit patterns U5a and one unit pattern U5b, or one unit pattern U5a and two unit patterns U5b are connected together.

In FIG. 17, as a part of the electrode pattern PT, only the connection points at which three line fragments T are connected together are depicted; however, the number of line fragments T is not limited to three and the electrode pattern PT may include connection points at which line fragments T of any number except three are connected together. For example, as in FIGS. 11 and 12, at an end of line fragment Ta or Tb which is not shared by a plurality of unit patterns U5a and U5b on the edge of the electrode pattern PT, there will be a two-way diverging connection point at which one line fragment Ta and one line fragment Tb are connected to each other.

Furthermore, in the example of FIG. 17, line fragments Ta and Tb are depicted to connect to each other at an acute or obtuse angle at the connection point; however, line fragments Ta and Tb may connect to each other at right angles.

### Sixth Embodiment

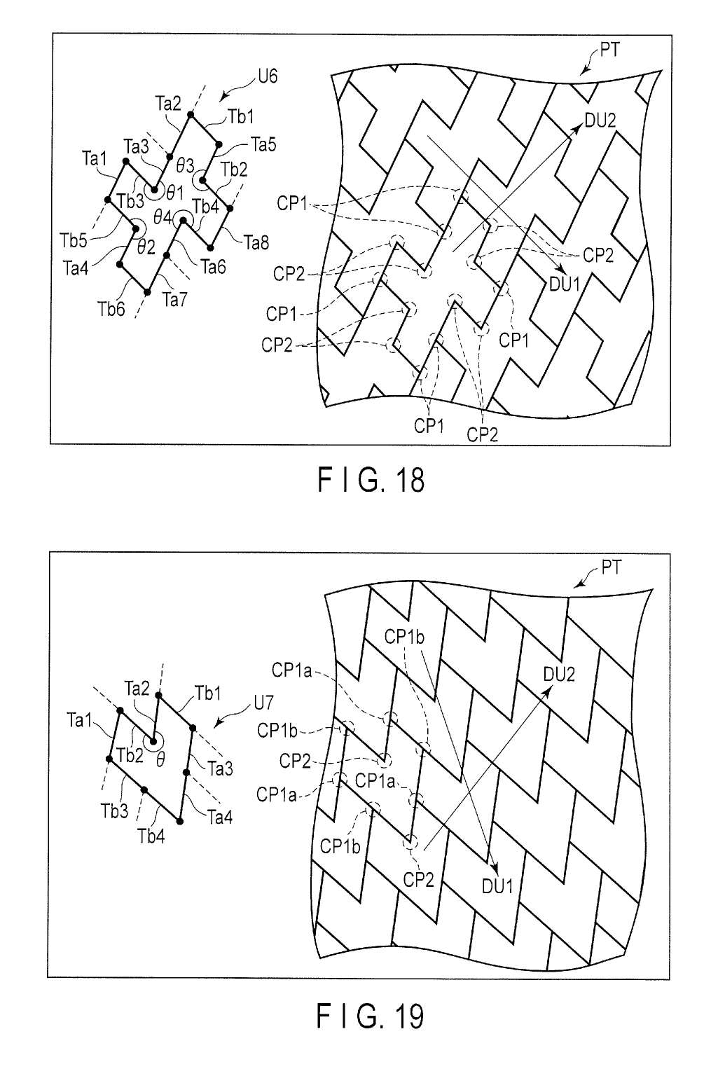

FIG. 18 schematically shows a part of the electrode pattern PT of the sixth embodiment. Unit pattern U6 is shown at the left of FIG. 18. The electrode pattern PT is a set of unit patterns U6 arranged in both first arrangement direction DU1 and second arrangement direction DU2. Unit pattern U6 is a dodecagon defined by (or closed by) line fragments Ta1, Ta2, Ta3, Ta4, Ta5, Ta6, Ta1, Ta8, Tb1, Tb2, Tb3, Tb4, Tb5, and Tb6. In unit pattern U6, interior angle θ1 formed by line fragments Ta3 and Tb3, interior angle θ2 formed by line fragments Ta4 and Tb5, interior angle θ3 formed by line fragments Ta5 and Tb2, and interior angle θ4 formed by line fragments Ta6 and Tb4 of unit pattern U6 are all greater than 180° (θ1, θ2, θ3, and θ4>180°).

In this electrode pattern PT, the outlines of two adjacent unit patterns U6 are formed to share at least one line fragment T. For example, in the two unit patterns U6 arranged consecutively in first arrangement direction DU1, the outlines of these two unit patterns U6 are formed such that two line fragments Ta and one line fragment Tb disposed at their boundary constitute line fragments Ta1, Ta3, and Tb3 of one unit pattern U6 and also line fragments Ta6, Ta8, and Tb4 of the other unit pattern U6.

The electrode pattern PT includes a number of connection points each of which bring together the ends of three line fragments T. For example, as shown in FIG. 18, connection point CP1a in which two line fragments Ta and one line fragment Tb are connected together is formed at each end of line fragments Ta and Tb which are shared by two adjacent unit patterns U6.

At each connection point CP1, two line fragments T are connected to each other linearly and one line fragment T is connected to these two line fragments T at any angle except 180°. Therefore, three line fragments T form substantially a T-shape defined by connection points CP1.

For example, one connection point CP1 involves two line fragments Ta constituting line fragment Ta2 and line fragment Ta3 of first unit pattern U6 and one line fragment Tb constituting line fragment Tb2 of second unit pattern U6 which is adjacent to the first unit pattern U6.

At connection points CP1 in FIG. 18, three unit patterns U6 are connected together.

As exemplified in FIG. 18, the electrode pattern PT of the present embodiment includes two-way diverging connection point CP2 at which one line fragment Ta and one line fragment Tb are connected to each other. Furthermore, as in FIGS. 11 and 12, at an end of line fragment Ta or Tb which is not shared by a plurality of unit patterns U3a and U3b on the edge of the electrode pattern PT, there will be a two-way diverging connection point at which one line fragment Ta and one line fragment Tb are connected to each other.

For example, one connection point CP2 involves the ends of line fragment Ta5 and line fragment Tb1 of unit pattern U6.

Furthermore, in the example of FIG. 18, line fragments Ta and Tb are depicted to connect to each other at an acute or obtuse angle at the connection point; however, line fragments Ta and Tb may connect to each other at right angles.

### Seventh Embodiment

FIG. 19 schematically shows a part of the electrode pattern PT of the seventh embodiment. Unit pattern U7 is shown at the left of FIG. 19. The electrode pattern PT is a set of unit patterns U7 arranged in both first arrangement direction DU1 and second arrangement direction DU2. Unit pattern U7 is a hexagon defined by (or closed by) line fragments Ta1, Ta2, Ta3, Ta4, Tb1, Tb2, Tb3, and Tb4. Interior angle θ formed by line fragments Ta2 and Tb2 of unit pattern U7 is greater than 180° (θ>180°).

In this electrode pattern PT, the outlines of two adjacent unit patterns U7 are formed to share at least one line fragment T. For example, in the two unit patterns U7 arranged consecutively in first arrangement direction DU1, the outlines of these two unit patterns U7 are formed such that one line fragment Ta and one line fragment Tb disposed at their boundary constitute line fragments Ta2 and Tb2 of one unit pattern U7 and also line fragments Ta4 and Tb4 of the other unit pattern U7.

For example, one connection point CP1a involves two line fragments Ta constituting line fragment Ta1 of first unit pattern U7 and line fragment Ta2 of second unit pattern U7, which is adjacent to the first unit pattern U7, and one line fragment Tb constituting line fragment Tb3 of the first unit pattern U7 and line fragment Tb1 of the second unit pattern U7.

For example, one connection point CP1b involves one line fragment Ta constituting line fragment Ta3 of the first unit pattern U7 and two line fragments Tb constituting line fragment Tb1 of the first unit pattern U7 (which doubles as line fragment Tb3 of the second unit pattern U7, which is adjacent to the first unit pattern U7) and line fragment Tb4 of the second unit pattern U7.

The electrode pattern PT includes a number of connection points each of which bring together the ends of three line fragments T. For example, as shown in FIG. 19, connection point CP1a in which two line fragments Ta and one line fragment Tb are connected together and connection point CP1b in which one line fragment Ta and two line fragments Tb are connected together are formed at each end of line fragments Ta and Tb which are shared by two adjacent unit patterns U7.

At each of connection points CP1a and CP1b, two line fragments T are connected to each other linearly and one line fragment T is connected to these two line fragments T at any angle except 180°. Therefore, three line fragments T form substantially a T-shape defined by connection points CP1.

At connection points CP1a and CP1b in FIG. 18, three unit patterns U7 are connected together.

As exemplified in FIG. 19, the electrode pattern PT of the present embodiment includes two-way diverging connection point CP2 at which one line fragment Ta and one line fragment Tb are connected to each other. For example, one connection point CP2 involves the ends of line fragment Ta2 and line fragment Tb2 of unit pattern U7. Furthermore, as in FIGS. 11 and 12, at an end of line fragment Ta or Tb which is not shared by a plurality of unit patterns U7 on the edge of the electrode pattern PT, there will be a two-way diverging connection point at which one line fragment Ta and one line fragment Tb are connected to each other.

Furthermore, in the example of FIG. 19, line fragments Ta and Tb are depicted to connect to each other at an acute or obtuse angle at the connection point; however, line fragments Ta and Tb may connect to each other at right angles.

### Eighth Embodiment

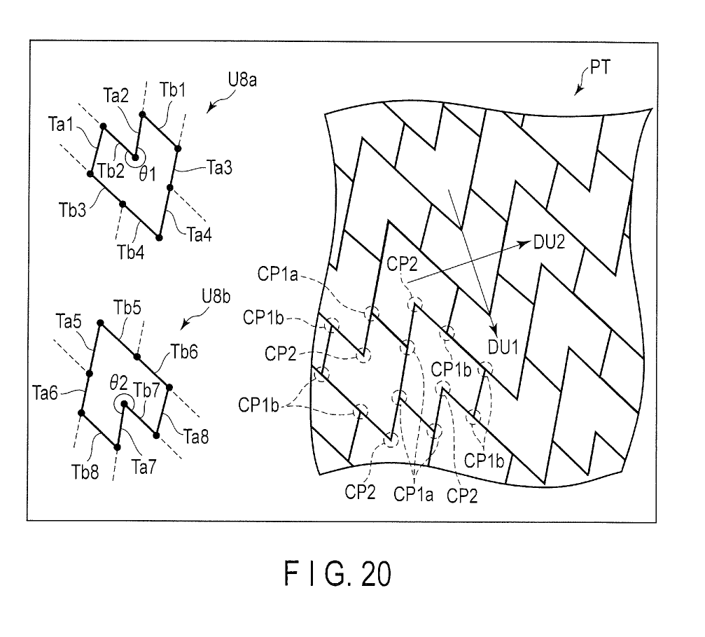

FIG. 20 schematically shows a part of the electrode pattern PT of the eighth embodiment. Unit patterns U8a and U8b are shown at the left of FIG. 20. The electrode pattern PT is a combination of unit patterns U8a and U8b. Specifically, in this electrode pattern PT, unit patterns U8a and U8b both extending in first arrangement direction DU1 are arranged alternately in second arrangement direction DU2. Unit pattern U8a is a hexagon defined by (or closed by) line fragments Ta1, Ta2, Ta3, Ta4, Tb1, Tb2, Tb3, and Tb4. Unit pattern U8b is a hexagon defined by (or closed by) line fragments Ta5, Ta6, Ta7, Ta8, Tb5, Tb6, Tb7, and Tb8. Unit patterns U8a and U8b are symmetrical with respect to the axis along second arrangement direction DU2. Interior angle θ1 formed by line fragments Ta2 and Tb2 of unit pattern U8a and interior angle θ2 formed by line fragments Ta7 and Tb7 of unit pattern U8b are both greater than 180° (θ1 and θ2>180°).

In this electrode pattern PT, the outlines of two adjacent unit patterns U8a, the outlines of two adjacent unit patterns U8b, and the outlines of adjacent unit patterns U8a and U8b are formed to share at least one line fragment T. For example, in the two unit patterns U8a arranged consecutively in first arrangement direction DU1, the outlines of these two unit patterns U8a are formed such that one line fragment Ta and one line fragment Tb disposed at their boundary constitute line fragments Ta2 and Tb2 of one unit pattern U8a and also line fragments Ta4 and Tb4 of the other unit pattern U8a.

Furthermore, for example, in the two unit patterns U8b arranged consecutively in first arrangement direction DU1, the outlines of these two unit patterns U8b are formed such that one line fragment Ta and one line fragment Tb disposed at their boundary are constitute line fragments Ta5 and Tb5 of one unit pattern U8b and also line fragments Ta1 and Tb7 of the other unit pattern U8b.

One unit pattern U8a is adjacent to four unit patterns U8b. The outline of this unit pattern U8a is formed such that its line fragments Ta1, Ta3, Tb1, and Tb3 are shared by the outlines of the four unit patterns U8b.

Furthermore, one unit pattern U8b is adjacent to four unit patterns U8a. The outline of this unit pattern U8b is formed such that its line fragments Ta6, Ta8, Tb6, and Tb8 are shared by the outlines of the four unit patterns U8a.

The electrode pattern PT includes a number of connection points each of which bring together the ends of three line fragments T. For example, as shown in FIG. 20, connection point CP1a in which two line fragments Ta and one line fragment Tb are connected together and connection point CP1b in which one line fragment Ta and two line fragments Tb are connected together are formed at each end of line fragments Ta and Tb which are shared by two adjacent unit patterns U8a and U8b.

At each of connection points CP1a and CP1b, two line fragments T are connected to each other linearly and one line fragment T is connected to these two line fragments T at any angle except 180°. Therefore, three line fragments T form substantially a T-shape defined by connection points CP1a and CP1b.

For example, one connection point CP1a involves two line fragments Ta constituting line fragment Ta3 of unit pattern U8a (which doubles as line fragment Ta6 of unit pattern U8b) and line fragment Ta4 of unit pattern U8a and one line fragment Tb constituting line fragment Tb1 of unit pattern U8b.

For example, one connection point CP1b involves one line fragment Ta constituting line fragment Ta1 of unit pattern U8a and two line fragments Tb constituting line fragment Tb3 of unit pattern U8a (which doubles as line fragment Tb6 of unit pattern U8b) and line fragment Tb5 of unit pattern U8b.

At connection points CP1a and CP1b in FIG. 20, two unit patterns U8a and one unit pattern U8b, or one unit pattern U8a and two unit patterns U8b are connected together.

As exemplified in FIG. 20, the electrode pattern PT of the present embodiment includes two-way diverging connection point CP2 at which one line fragment Ta and one line fragment Tb are connected to each other. For example, one connection point CP2 of unit pattern U8a involves the end of line fragment Ta and line fragment Tb2. Furthermore, as in FIGS. 11 and 12, at an end of line fragment Ta or Tb which is not shared by a plurality of unit patterns U8a and U8b on the edge of the electrode pattern PT, there will be a two-way diverging connection point at which one line fragment Ta and one line fragment Tb are connected to each other.

Furthermore, in the example of FIG. 20, line fragments Ta and Tb are depicted to connect to each other at an acute or obtuse angle at the connection point; however, line fragments Ta and Tb may connect to each other at right angles.

### Ninth Embodiment

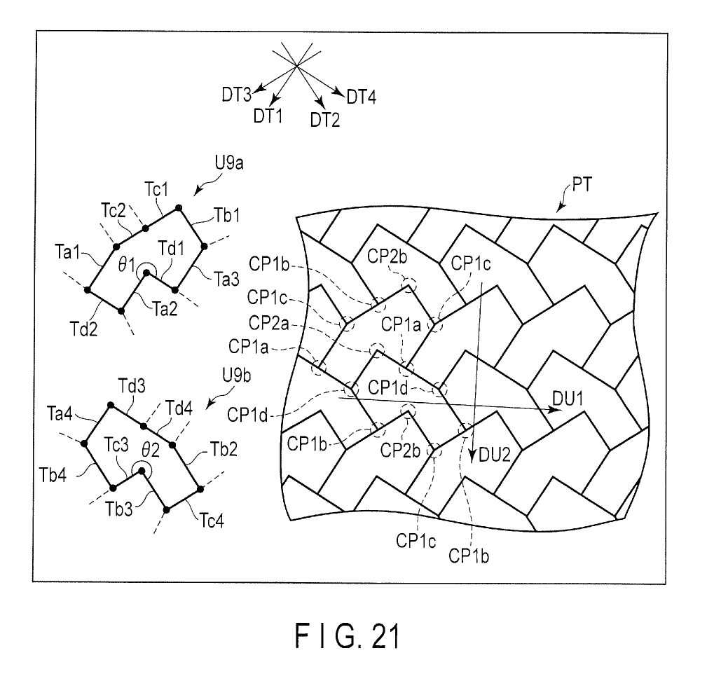

FIG. 21 schematically shows a part of the electrode pattern PT of the ninth embodiment. Unit patterns U9a and U9b are shown at the left of FIG. 21. The electrode pattern PT is a combination of unit patterns U9a and U9b. Specifically, in this electrode pattern PT, unit patterns U9a and U9b both extending in first arrangement direction DU1 are arranged alternately in second arrangement direction DU2.

Unit patterns U9a and U9b are composed of line fragments Ta and Tb, and in addition thereto, line fragments Tc and Td. Thin fragment Tc extends linearly in third extension direction DT3 which crosses first extension direction DT1 and second extension direction DT2. Thin fragment Td extends linearly in fourth extension direction DT4 which crosses first extension direction DT1, second extension direction DT2, and third extension direction DT3. Unit pattern U9a is a septagon defined by (or closed by) line fragments Ta1, Ta2, Ta3, Tb1, Tc1, Tc2, Td1, and Td2. Unit pattern U9b is a septagon defined by (or closed by) line fragments Ta4, Tb2, Tb3, Tb4, Tc3, Tc4, Td3, and Td4. Unit patterns U9a and U9b are symmetrical with respect to an axis along second arrangement direction DU2. Interior angle θ1 formed by line fragments Ta2 and Td1 of unit pattern U9a and interior angle θ2 formed by line fragments Tb3 and Tc3 of unit pattern U9b are both greater than 180° (θ1 and θ2>180°).

In this electrode pattern PT, the outlines of two adjacent unit patterns U9a, the outlines of two adjacent unit patterns U9b, and the outlines of adjacent unit patterns U9a and U9b are formed to share at least one line fragment T. For example, in the two unit patterns U9a arranged consecutively in first arrangement direction DU1, the outlines of these two unit patterns U9a are formed such that one line fragment Ta disposed at their boundary constitutes line fragment Ta1 of one unit pattern U9a and also line fragment Ta3 of the other unit pattern U9a.

Furthermore, for example, in the two unit patterns U9b arranged consecutively in first arrangement direction DU1, the outlines of these two unit patterns U9b are formed such that one line fragment Tb disposed at their boundary constitutes line fragment Tb2 of one unit pattern U9b and also as line fragment Tb4 of the other unit pattern U9b.

One unit pattern U9a is adjacent to four unit patterns U9b. The outline of this unit pattern U9a is formed such that its line fragments Ta2, Tb1, Tc1, Tc2, Td1 and Td2 are shared by the outlines of the four unit patterns U9b.

Furthermore, one unit pattern U9b is adjacent to four unit patterns U9a. The outline of this unit pattern U9b is formed such that its line fragments Ta4, Tb3, Tc3, Tc4, Td3, and Td4 are shared by the outlines of the four unit patterns U9a.

The electrode pattern PT includes a number of connection points each of which bring together the ends of three line fragments T. For example, as shown in FIG. 21, connection point CP1a in which one line fragment Ta and two line fragments Td are connected together; connection point CP1b in which one line fragment Tb and two line fragments Tc are connected together; connection point CP1c in which one line fragment Ta, one line fragment Tb, and one line fragment Tc are connected together; and connection point CP1d in which one line fragment Ta, one line fragment Tb, and one line fragment Td are connected together are formed at each end of line fragments Ta and Tb which are shared by two adjacent unit patterns U9a and U9b.

At each of connection points CP1a and CP1b, two line fragments T are connected to each other linearly and one line fragment T is connected to these two line fragments T at any angle except 180°. Therefore, three line fragments T form substantially a T-shape defined by connection points CP1a and CP1b.

On the other hand, at each of connection points CP1c and CP1d, three line fragments T are connected together nonlinearly. Therefore, three line fragments T form substantially a Y shape defined by connection points CP1c and CP1d.

As connection point CP1a in which one line fragment Ta and two line fragments Td are connected together, the following can be adopted, for example. One connection point CP1a involves one line fragment Ta constituting line fragment Ta1 of unit pattern U9a and two line fragments Td constituting line fragment Td2 of unit pattern U9a (which doubles as line fragment Td4 of unit pattern U9b) and line fragment Td3 of unit pattern U9b.

As connection point CP1b in which one line fragment Tb and two line fragments Tc are connected together, the following can be adopted, for example. One connection point CP1b involves one line fragment Tb constituting line fragment Tb2 of unit pattern U9b and two line fragments Tc constituting line fragment Tc1 of unit pattern U9a and line fragment Tc2 of unit pattern U9a (which doubles as line fragment Tc4 of unit pattern U9b).

As connection point CP1c in which one line fragment Ta, one line fragment Tb, and one line fragment Tc are connected together, the following can be adopted, for example. One connection point CP1c involves one line fragment Ta constituting line fragment Ta1 of unit pattern U9a, one line fragment Tb constituting line fragment Tb3 of unit pattern U9b, and one line fragment Tc constituting line fragment Tc2 of unit pattern U9a (which doubles as line fragment Tc4 of unit pattern U9b).

As connection point CP1d in which one line fragment Ta, one line fragment Tb, and one line fragment Td are connected together, the following can be adopted, for example. One connection point CP1d involves one line fragment Ta constituting line fragment Ta2 of unit pattern U9a, one line fragment Tb constituting line fragment Tb2 of unit pattern U9b, and one line fragment Td constituting line fragment Td2 of unit pattern U9a (which doubles as line fragment Td4 of unit pattern U9b).

At connection points CP1a, CP1b, CP1c, and CP1d in FIG. 21, two unit patterns U9a and one unit pattern U9b, or one unit pattern U9a and two unit patterns U9b are connected together.

As exemplified in FIG. 21, the electrode pattern PT of the present embodiment includes two-way diverging connection point CP2a at which one line fragment Ta and one line fragment Td are connected to each other, and two-way diverging connection point CP2b at which one line fragment Tb and one line fragment Tc are connected to each other. Furthermore, as in FIGS. 11 and 12, at an end of line fragment Ta, Tb, Tc, or Td which is not shared by a plurality of unit patterns U9a and U9b on the edge of the electrode pattern PT, there will be a two-way diverging connection point at which any two of line fragments Ta, Tb, Tc, and Td are connected to each other.

As two-way diverging connection point CP2a in which one line fragment Ta and one line fragment Td are connected to each other, the following can be adopted, for example. One connection point CP2a involves the ends of line fragments Ta2 and Td1 of unit pattern U9a.

As two-way diverging connection point CP2b in which one line fragment Tb and one line fragment Tc are connected to each other, the following can be adopted, for example. One connection point CP2a involves the ends of line fragments Tb1 and Tc1 of unit pattern U9a.

### Tenth Embodiment

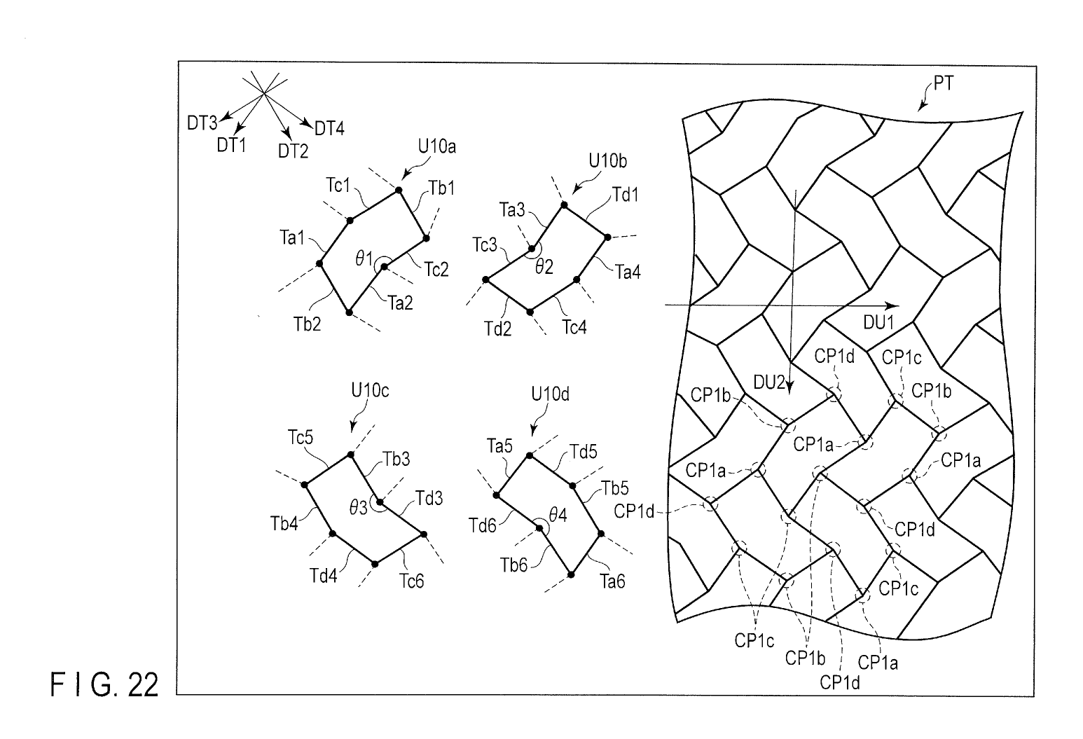

FIG. 22 schematically shows a part of the electrode pattern PT of the tenth embodiment. Unit patterns U10a, U10b, U10c, and U10d are shown at the left of FIG. 22. The electrode pattern PT is a combination of unit patterns U10a, U10b, U10c, and U10d. Specifically, in this electrode pattern PT, unit patterns U10a and U10b extending in first arrangement direction DU1 and unit patterns U10c and U10d extending in first arrangement direction DU1 are arranged alternately in second arrangement direction DU2.

Unit patterns U10a, U10b, U10c, and U10d are composed of line fragments Ta and Tb, and in addition thereto, line fragments Tc and Td. Thin fragment Tc extends linearly in third extension direction DT3 which crosses first extension direction DT1 and second extension direction DT2. Thin fragment Td extends linearly in fourth extension direction DT4 which crosses first extension direction DT1, second extension direction DT2, and third extension direction DT3.

Unit pattern U10a is a hexagon defined by (or closed by) line fragments Ta1, Ta2, Tb1, Tb2, Tc1, and Tc2. Unit pattern U10b is a hexagon defined by (or closed by) line fragments Ta3, Ta4, Tc3, Tc4, Td1, and Td2. Unit pattern U10c is a hexagon defined by (or closed by) line fragments Tb3, Tb4, Tc5, Tc6, Td3, and Td4. Unit pattern U10d is a hexagon defined by (or closed by) line fragments Ta5, Ta6, Tb5, Tb6, Td5, and Td6. Unit patterns U10a and U10b, unit patterns U10c and U10d, unit patterns U10a and U10d, and unit patterns U10b and U10c are symmetrical with respect to a predetermined axis. Interior angle θ1 formed by line fragments Ta2 and Tc2 of unit pattern U10a, interior angle θ2 formed by line fragments Ta3 and Tc3 of unit pattern U10b, interior angle θ3 formed by line fragments Tb3 and Td3 of unit pattern 10c, and interior angle θ4 formed by line fragments Tb6 and Td6 of unit pattern U10d are all greater than 180° (θ1, θ2, θ3, and θ4>180°).

In this electrode pattern PT, unit patterns U10a, U10b, U10c, and U10d do not adjoin a unit pattern of the same kind. That is, unit pattern U10a adjoins unit patterns U10b, U10c, and U10d. Unit pattern U10b adjoins unit patterns U10a, U10c, and U10d. Unit pattern U10c adjoins unit patterns U10a, U10b, and U10d. Unit pattern U10d adjoins unit patterns U10a, U10b, and U10c. The outlines of two adjacent unit patterns are formed to share at least one line fragment T. For example, in unit patterns U10a and U10b arranged consecutively in first arrangement direction DU1, the outlines of these unit patterns U10a and U10b are formed such that one line fragment Tc disposed at their boundary constitutes line fragment Tc2 in unit pattern U10a and line fragment Tc3 in unit pattern U10b.

In unit patterns U10a and U10c arranged consecutively in first arrangement direction DU2, the outlines of these unit patterns U10a and U10c are formed such that one line fragment Tc disposed at their boundary constitutes line fragment Tc1 in unit pattern U10a and line fragment Tc6 in unit pattern U10c.

In unit patterns U10a and U10d arranged consecutively in first arrangement direction DU2, the outlines of these unit patterns U10a and U10d are formed such that one line fragment Ta disposed at their boundary constitutes line fragment Ta2 in unit pattern U10a and line fragment Ta5 in unit pattern U10d.

The electrode pattern PT includes a number of connection points each of which bring together the ends of three line fragments T. For example, as shown in FIG. 22, connection point CP1a in which one line fragment Ta, one line fragment Tb, and one line fragment Tc are connected together; connection point CP1b in which one line fragment Ta, one line fragment Tc, and one line fragment Td are connected together; connection point CP1c in which one line fragment Ta, one line fragment Tb, and one line fragment Td are connected together; and connection point CP1d in which one line fragment Tb, one line fragment Tc, and one line fragment Td are connected together are formed at each end of line fragments Ta, Tb, Tc, and Td which are shared by any two of unit patterns U10a, U10b, U10c, and U10d.

At each of connection points CP1a, CP1b, CP1c, and CP1d, three line fragments T are connected together nonlinearly. Therefore, three line fragments T form substantially a Y shape defined by connection points CP1a, CP1b, CP1c, and CP1d.

As connection point CP1a in which one line fragment Ta, one line fragment Tb, and one line fragment Tc are connected together, the following can be adopted, for example. One connection point CP1a involves one line fragment Ta constituting line fragment Ta3 of unit pattern U10b and line fragment Ta6 of unit pattern U10d, one line fragment Tb constituting line fragment Tb1 of unit pattern U10a and line fragment Tb6 of unit pattern 10d, and one line fragment Tc constituting line fragment Tc2 of unit pattern U10a and line fragment Tc3 of unit pattern U10b.

As connection point CP1b in which one line fragment Ta, line fragment Tc, and line fragment Td are connected together, the following can be adopted, for example. One connection point CP1b involves one line fragment Ta constituting line fragment Ta1 of unit pattern U10a and line fragment Ta4 of unit pattern U10b, one line fragment Tc constituting line fragment Tc1 of unit pattern U10a and line fragment Tc6 of unit pattern U10c, and one line fragment Td constituting line fragment Td1 of unit pattern U10b and line fragment Td4 of unit pattern U10c.

As connection point CP1c in which one line fragment Ta, line fragment Tb, and line fragment Td are connected together, the following can be adopted, for example. One connection point CP1c involves one line fragment Ta constituting line fragment Ta3 of unit pattern U10b and line fragment Ta6 of unit pattern U10d, one line fragment Tb constituting line fragment Tb4 of unit pattern U10c and line fragment Tb5 of unit pattern U10d, and one line fragment Td constituting line fragment Td1 of unit pattern U10b and line fragment Td4 of unit pattern U10c.

As connection point CP1d in which one line fragment Tb, line fragment Tc, and line fragment Td are connected together, the following can be adopted, for example. One connection point CP1d involves one line fragment Tb constituting line fragment Tb4 of unit pattern U10c and line fragment Tb5 of unit pattern U10d, one line fragment Tc constituting line fragment Tc4 of unit pattern U10b and line fragment Tc5 of unit pattern U10c, and one line fragment Td constituting line fragment Td2 of unit pattern U10b and line fragment Td5 of unit pattern U10d.

At connection points CP1a, CP1b, CP1c, and CP1d in FIG. 22, any three of unit patterns U10a, U10b, U10c, and U10d are connected together.

As in FIGS. 11 and 12, at an end of line fragment Ta, Tb, Tc, or Td which is not shared by a plurality of unit patterns U10a, U10b, U10c, and U10d on the edge of the electrode pattern PT, there will be a two-way diverging connection point at which any two of line fragments Ta, Tb, Tc, and Td are connected to each other.

The connection points in the electrode patterns PT of second to tenth embodiments are, basically, diverging three ways. Therefore, the electrode patterns PT of the above embodiments can prevent or suppress moiré as achieved in the first embodiment.

In addition thereto, the same advantage obtained in the first embodiment can be achieved by the second to tenth embodiments.

As in the second to fifth and eighth to tenth embodiments, since the electrode pattern PT is composed of various kinds of unit patterns U, and as particularly in the third, fourth, sixth to tenth embodiments, since the electrode pattern PT is composed of unit patterns U having a polygonal outline (excluding quadrangle) including at least one interior angle greater than 180°, the electrode pattern PT is complex and the detection performance of the sensor SE can be maintained good. That is, if an area in which the common electrode CE and line fragments T are not opposed to each other spreads widely over the detection surface, approach of a finger of a user may not be detected therein. On the other hand, if the electrode pattern PT is complex as in the above, such an area can be reduced and the detection performance of the sensor SE can be maintained good.

Furthermore, in the tenth embodiment, various unit patterns are composed of various line fragments T and the electrode pattern PT is composed of these various unit patterns. Consequently, aligning connections points linearly is difficult in this embodiment. In the liquid crystal display device DSP with this electrode pattern PT, the advantage of preventing or suppressing moiré due to the interference between the display area DA and the electrode pattern PT is more effective.

In the first to tenth embodiments, the same patterns constituting the electrode patterns PT of the embodiments can be applied to the dummy electrodes DR. In that case, the pattern formed of dummy electrodes DR may be designed such that ends of line fragments included in the dummy electrodes DR do not contact each other to have the dummy electrodes DR in an electrically floating state.

The embodiments explained above can be varied arbitrarily. Some examples of variations are described hereinafter.

(Variation 1)

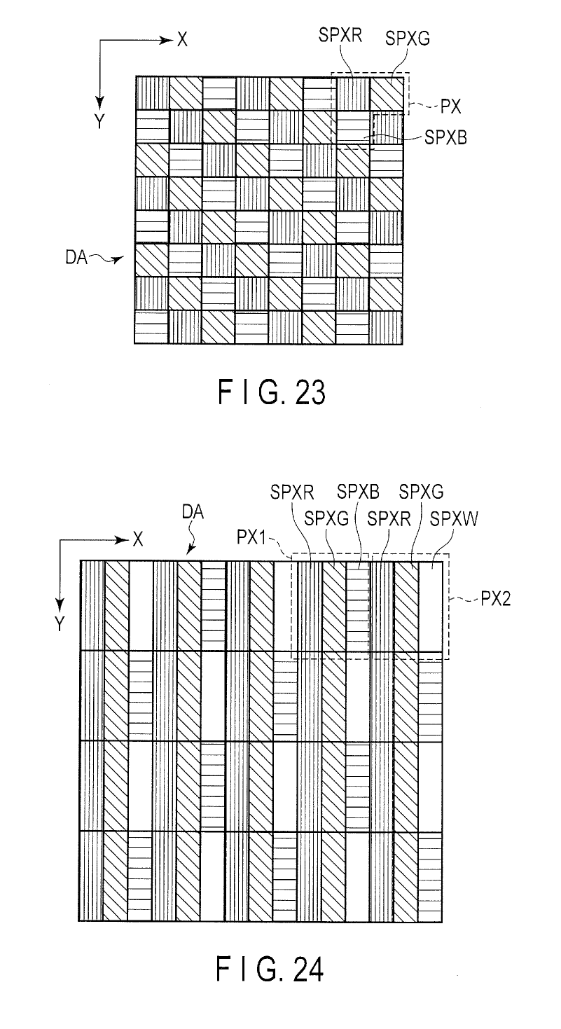

Pixel arrangements within the display area DA are not limited to those shown in FIGS. 11 and 12. In this variation, another pixel arrangement within the display area DA is explained with reference to FIG. 23. In the display area DA of FIG. 23, red subpixel SPXR, green subpixel SPXG, and blue subpixel SPXB are arranged in a matrix extending in direction X and direction Y. Subpixels SPXR, SPXG, and SPXB are arranged such that the subpixels of the same color do not continue in either direction X or direction Y. A unit pixel PX is composed of subpixels SPXR and SPXG arranged side by side in direction X and a subpixel SPXB below the subpixel SPXR.

The same advantages obtained in the above embodiments can be achieved as well in such a display area DA.

(Variation 2)

In this variation, another pixel arrangement within the display area DA is explained with reference to FIG. 24. In the display area DA of FIG. 24, red subpixel SPXR, green subpixel SPXG, blue subpixel SPXB, and white subpixel SPXW are arranged in a matrix extending in direction X and direction Y. The display area DA includes two kinds of unit pixels PX1 and PX2. Unit pixel PX1 is composed of subpixels SPXR, SPXG, and SPXB arranged in direction X. Unit pixel PX2 is composed of subpixels SPXR, SPXG, and SPXB arranged in direction X. Unit pixels PX1 and PX2 are arranged alternately in direction X. Furthermore, unit pixels PX1 and PX2 are arranged alternately in direction Y.

The same advantages obtained in the above embodiments can be achieved as well in such a display area DA.

Variation 2 exemplifies a use of white pixel; however, a subpixel may be of different color such as yellow.

Based on the structures which have been described in the above-described embodiment and variations, a person having ordinary skill in the art may achieve structures with arbitral design changes; however, as long as they fall within the scope and spirit of the present invention, such structures are encompassed by the scope of the present invention. For example, the electrode patterns PT only including a part designed based on the technical concept of the above-described embodiment and variations should be acknowledged made within the scope of the invention, and actual products with minor differences and design changes caused by their production process should never be acknowledged beyond the scope of the invention.

Furthermore, regarding the present embodiments, any advantage and effect those will be obvious from the description of the specification or arbitrarily conceived by a skilled person are naturally considered achievable by the present invention.

Some examples of a sensor-equipped display device obtained from the embodiments are described below.

[1] A sensor-equipped display device, comprising:

a display panel including a display area in which a plurality of pixels are arranged; and

a detection electrode including an electrode pattern having conductive line fragments arranged on a detection surface which is parallel to the display area, the detection electrodes configured to detect a contact or approach of an object to the detection surface, wherein

the electrode pattern includes a connection point at which ends of three line fragments are connected together.

[2] The sensor-equipped display device according to the example [1], wherein

two of the three line fragments are connected linearly at the connection point.

[3] The sensor-equipped display device according to the example [1], wherein

the three line fragments are connected nonlinearly at the connection point.

[4] The sensor-equipped display device according to the example [1], wherein

the electrode pattern includes a plurality of unit patterns of which outline is closed by the line fragments, and

outlines of the unit patterns adjacent to each other share at least one line fragment.

[5] The sensor-equipped display device according to the example [4], wherein

outlines of the three unit patterns contact each other at the connection point.

[6] The sensor-equipped display device according to the example [4], wherein

the outline of the unit pattern is a polygonal except a quadrangle.

[7] The sensor-equipped display device according to the example [6], wherein

the outline of the unit pattern has at least one interior angle greater than 180°.

[8] The sensor-equipped display device according to the example [1], wherein

the electrode pattern includes different kinds of unit patterns of which outlines are closed by the line fragments individually, and

the outlines of the different kinds of unit patterns have different shapes.

[9] The sensor-equipped display device according to the example [8], wherein

the outlines of the three unit patterns contact each other at the connection point.

[10] The sensor-equipped display device according to the example [8], wherein

the outline of the unit pattern is a polygonal except a quadrangle.

[11] The sensor-equipped display device according to the example [10], wherein

the outline of the unit pattern has at least one interior angle greater than 180°.

[12] The sensor-equipped display device according to the example [1], comprising:

a driving electrode configured to form a capacitance with the detection electrode; and

a detection circuit configured to detect a contact or approach of an object to the detection surface based on a change in the capacitance, wherein

the line fragment includes a metal material, and

the driving electrode includes a transmissive material and is disposed in a layer different from the detection electrode in a normal direction of the display area to be opposed to the detection electrode with a dielectric intervening therebetween.

[13] The sensor-equipped display device according to the example [1], wherein the display panel comprises a common electrode forming a capacitance with the detection electrode, and a pixel electrode provided with each subpixel to be opposed to the common electrode with an insulating film intervening therebetween, and

the display device further comprises a detection circuit configured to detect a contact or approach of an object to the detection surface based on a change in the capacitance, and a driving circuit configured to supply a first driving signal for driving the subpixels and a second driving signal for forming the capacitance used by the detection circuit to detect a contact or approach of an object to the detection surface, selectively, to the common electrode.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A sensor-equipped display device, comprising:
a display panel including a display area in which a plurality of pixels are arranged; and
a detection electrode including an electrode pattern having conductive line fragments arranged on a detection surface which is parallel to the display area, the detection electrodes configured to detect a contact or approach of an object to the detection surface, wherein
the electrode pattern includes a connection point at which ends of three line fragments are connected together.

2. The sensor-equipped display device according to claim 1, wherein
two of the three line fragments are connected linearly at the connection point.

3. The sensor-equipped display device according to claim 1, wherein
the three line fragments are connected nonlinearly at the connection point.

4. The sensor-equipped display device according to claim 1, wherein
the electrode pattern includes a plurality of unit patterns of which outline is closed by the line fragments, and
outlines of the unit patterns adjacent to each other share at least one line fragment.

5. The sensor-equipped display device according to claim 4, wherein
outlines of the three unit patterns contact each other at the connection point.

6. The sensor-equipped display device according to claim 4, wherein
the outline of the unit pattern is a polygonal except a quadrangle.

7. The sensor-equipped display device according to claim 6, wherein
the outline of the unit pattern has at least one interior angle greater than 180°.

8. The sensor-equipped display device according to claim 1, wherein
the electrode pattern includes different kinds of unit patterns of which outlines are closed by the line fragments individually, and
the outlines of the different kinds of unit patterns have different shapes.

9. The sensor-equipped display device according to claim 8, wherein
the outlines of the three unit patterns contact each other at the connection point.

10. The sensor-equipped display device according to claim 8, wherein
the outline of the unit pattern is a polygonal except a quadrangle.

11. The sensor-equipped display device according to claim 10, wherein
the outline of the unit pattern has at least one interior angle greater than 180°.

12. The sensor-equipped display device according to claim 1, comprising:
a driving electrode configured to form a capacitance with the detection electrode; and
a detection circuit configured to detect a contact or approach of an object to the detection surface based on a change in the capacitance, wherein
the line fragment includes a metal material, and
the driving electrode includes a transmissive material and is disposed in a layer different from the detection electrode in a normal direction of the display area to be opposed to the detection electrode with a dielectric intervening therebetween.

13. The sensor-equipped display device according to claim 1, wherein the display panel comprises a common electrode forming a capacitance with the detection electrode, and a pixel electrode provided with each subpixel to be opposed to the common electrode with an insulating film intervening therebetween, and
the display device further comprises a detection circuit configured to detect a contact or approach of an object to the detection surface based on a change in the capacitance, and a driving circuit configured to supply a first driving signal for driving the subpixels and a second driving signal for forming the capacitance used by the detection circuit to detect a contact or approach of an object to the detection surface, selectively, to the common electrode.
